(19) United States
(12) Patent Application Publication
(10) Pub. No.: US 2026/0275925 A1
(43) Pub. Date: Sep. 17, 2026

(54) MOBILE SYSTEM FOR POWER GENERATION

(71) Applicant: John Wagoner SCHILLEREFF, Willis, TX (US)

(72) Inventor: John Wagoner SCHILLEREFF, Willis, TX (US)

(21) Appl. No.: 19/563,725

(22) Filed: Mar. 11, 2026

Related U.S. Application Data
(60) Provisional application No. 63/770,084, filed on Mar. 11, 2025.

(51) Int. Cl. F02D 29/06; F02B 63/04; H02K 7/116; H02K 7/18

(52) U.S. Cl. CPC F02D 29/06; F02B 63/042; F02B 63/047; H02K 7/116; H02K 7/1815

(57) ABSTRACT

Various embodiments are directed to a system for generating power. A system for generating power includes a power generation unit. The power generation unit includes an internal combustion engine, a gearbox operably coupled to the internal combustion engine with the gearbox including a reduction gearbox that has a reduction ratio ranging from 1.1:1 to 5:1, and a generator connected to the gearbox with the generator providing power to one or more output devices. The power generation unit also includes a computing device for controlling the power generation unit. The computing device controls the power generation unit based on one or more characteristics relating to the power generation unit.

### CROSS-REFERENCE TO RELATED APPLICATION

The present application claims the benefit of and priority to U.S. Provisional Patent Application No. 63/770,084, filed Mar. 11, 2025, and titled “MOBILE SYSTEM FOR POWER GENERATION”, the contents of which are incorporated herein by reference in its entirety for all purposes.

### FIELD

The present disclosure relates generally to power generation, and more particularly to a system for power generation.

### BACKGROUND

Generating power for use at remote locations often requires a large amount of fuel and harmful emissions. However, current generation systems are large and often require specialized vehicles for transport. As such, there exists a need for a system for power generation that improves efficiency and reduces emissions without reducing the power output.

### BRIEF SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

In some aspects, the techniques described herein relate to a system for generating power, the system including: a power generation unit including: an internal combustion engine, a gearbox operably coupled to the internal combustion engine, wherein the gearbox includes a reduction gearbox that has a reduction ratio ranging from 1.1:1 to 5:1, and a generator connected to the gearbox, wherein the generator provides power to one or more output devices; and a computing device for controlling the power generation unit, wherein the computing device controls the power generation unit based on one or more characteristics relating to the power generation unit.

In some aspects, the techniques described herein relate to a system, wherein the reduction gearbox is structured to provide from approximately 2:1 to approximately 2.5:1 reduction ratio.

In some aspects, the techniques described herein relate to a system, wherein the reduction gearbox increases torque by changing a revolutions per minute provided to the generator.

In some aspects, the techniques described herein relate to a system, wherein the reduction gearbox allows for the revolutions per minute to be consistent with an operating parameter of the generator.

In some aspects, the techniques described herein relate to a system, wherein the gearbox receives an input torque at an input speed from the internal combustion engine and outputs an output torque at an output speed to the generator, wherein the output torque is higher than the input torque based on the reduction ratio and an efficiency of the gearbox.

In some aspects, the techniques described herein relate to a system, wherein the input speed is higher than the output speed based on the reduction ratio and the efficiency of the gearbox.

In some aspects, the techniques described herein relate to a system, wherein the gearbox includes a plurality of gears to convert the input torque at the input speed into the output torque at the output speed.

In some aspects, the techniques described herein relate to a system, wherein the efficiency of the gearbox is at least 95%.

In some aspects, the techniques described herein relate to a system, wherein the gearbox is structured to reduce a revolutions per minute provided to the generator from the internal combustion engine.

In some aspects, the techniques described herein relate to a system, wherein the internal combustion engine is fueled via natural gas or diesel.

In some aspects, the techniques described herein relate to a system, wherein the power generation unit further includes a frame, wherein the frame allows the power generation unit to be moved.

In some aspects, the techniques described herein relate to a system, wherein the power generation unit is mobile via a trailer.

In some aspects, the techniques described herein relate to a system, wherein the internal combustion engine is structured to operate on flare gas.

In some aspects, the techniques described herein relate to a system, wherein the one or more characteristics include a methane content of the flare gas, wherein the computing device adjusts an operation of the internal combustion engine based on the methane content.

In some aspects, the techniques described herein relate to a system, further including one or more sensors for monitoring the power generation unit.

In some aspects, the techniques described herein relate to a system, wherein the one or more sensors include at least one of an engine sensor, a gearbox sensor, or a generator sensor.

In some aspects, the techniques described herein relate to a system, wherein the one or more characteristics are related to an output of the generator to the one or more output devices.

In some aspects, the techniques described herein relate to a system, wherein the reduction ratio is based on an RPM of the internal combustion engine and a desired RPM of the generator.

In some aspects, the techniques described herein relate to a system, wherein the one or more characteristics include at least one of temperature, pressure, voltage, or frequency.

In some aspects, the techniques described herein relate to a system, wherein the one or more characteristics relate to at least one of the generator or the internal combustion engine.

In some aspects, the techniques described herein relate to a power generation unit including: an internal combustion engine, a gearbox operably coupled to the internal combustion engine, wherein the gearbox includes a reduction gearbox that has a reduction ratio ranging from 1.1:1 to 5:1, and a generator connected to the gearbox, wherein the generator provides power to one or more output devices.

In some aspects, the techniques described herein relate to a power generation unit, wherein the reduction gearbox is structured to provide from approximately 2:1 to approximately 2.5:1 reduction ratio.

In some aspects, the techniques described herein relate to a power generation unit, wherein the reduction gearbox increases torque by changing a revolutions per minute provided to the generator.

In some aspects, the techniques described herein relate to a power generation unit, wherein the reduction gearbox allows for the revolutions per minute to be consistent with an operating parameter of the generator.

In some aspects, the techniques described herein relate to a power generation unit, wherein the gearbox receives an input torque at an input speed from the internal combustion engine and outputs an output torque at an output speed to the generator, wherein the output torque is higher than the input torque based on the reduction ratio and an efficiency of the gearbox.

In some aspects, the techniques described herein relate to a power generation unit, wherein the input speed is higher than the output speed based on the reduction ratio and the efficiency of the gearbox.

In some aspects, the techniques described herein relate to a power generation unit, wherein the gearbox includes a plurality of gears to convert the input torque at the input speed into the output torque at the output speed.

In some aspects, the techniques described herein relate to a power generation unit, wherein the efficiency of the gearbox is at least 95%.

In some aspects, the techniques described herein relate to a power generation unit, wherein the gearbox is structured to reduce a revolutions per minute provided to the generator from the internal combustion engine.

In some aspects, the techniques described herein relate to a power generation unit, wherein the internal combustion engine is fueled via natural gas or diesel.

In some aspects, the techniques described herein relate to a power generation unit, wherein the power generation unit further includes a frame, wherein the frame allows the power generation unit to be moved.

In some aspects, the techniques described herein relate to a power generation unit, wherein the power generation unit is mobile via a trailer.

In some aspects, the techniques described herein relate to a power generation unit, wherein the internal combustion engine is structured to operate on flare gas.

In some aspects, the techniques described herein relate to a power generation unit, further including one or more sensors for monitoring the power generation unit.

In some aspects, the techniques described herein relate to a power generation unit, wherein the one or more sensors include at least one of an engine sensor, a gearbox sensor, or a generator sensor.

In some aspects, the techniques described herein relate to a power generation unit, wherein the reduction ratio is based on an RPM of the internal combustion engine and a desired RPM of the generator.

In some aspects, the techniques described herein relate to a method of manufacturing a power generation unit, the method including: providing an internal combustion engine, coupling a gearbox to the internal combustion engine, wherein the gearbox includes a reduction gearbox that has a reduction ratio ranging from 1.1:1 to 5:1, and connecting a generator to the gearbox, wherein the generator provides power to one or more output devices.

In some aspects, the techniques described herein relate to a method, wherein the reduction gearbox is structured to provide from approximately 2:1 to approximately 2.5:1 reduction ratio.

In some aspects, the techniques described herein relate to a method, wherein the reduction gearbox increases torque by changing a revolutions per minute provided to the generator.

In some aspects, the techniques described herein relate to a method, wherein the reduction gearbox allows for the revolutions per minute to be consistent with an operating parameter of the generator.

In some aspects, the techniques described herein relate to a method, wherein the gearbox receives an input torque at an input speed from the internal combustion engine and outputs an output torque at an output speed to the generator, wherein the output torque is higher than the input torque based on the reduction ratio and an efficiency of the gearbox.

In some aspects, the techniques described herein relate to a method, wherein the input speed is higher than the output speed based on the reduction ratio and the efficiency of the gearbox.

In some aspects, the techniques described herein relate to a method, wherein the gearbox includes a plurality of gears to convert the input torque at the input speed into the output torque at the output speed.

In some aspects, the techniques described herein relate to a method, wherein the efficiency of the gearbox is at least 95%.

In some aspects, the techniques described herein relate to a method, wherein the gearbox is structured to reduce a revolutions per minute provided to the generator from the internal combustion engine.

In some aspects, the techniques described herein relate to a method, wherein the internal combustion engine is fueled via natural gas or diesel.

In some aspects, the techniques described herein relate to a method, wherein the power generation unit further includes a frame, wherein the frame allows the power generation unit to be moved.

In some aspects, the techniques described herein relate to a method, wherein the power generation unit is mobile via a trailer.

In some aspects, the techniques described herein relate to a method, wherein the internal combustion engine is structured to operate on flare gas.

In some aspects, the techniques described herein relate to a method, further including providing one or more sensors for monitoring the power generation unit.

In some aspects, the techniques described herein relate to a method, wherein the one or more sensors include at least one of an engine sensor, a gearbox sensor, or a generator sensor.

In some aspects, the techniques described herein relate to a method, wherein the reduction ratio is based on an RPM of the internal combustion engine and a desired RPM of the generator.

In some implementations, the power generation unit is mounted on a trailer to form a mobile generator package, and in some implementations the power generation unit is packaged in an enclosed trailer. Example implementations may provide about 900 kW to about 1100 kW continuous output in a compact package, including an overall length on the order of about 172 inches and a weight of less than about 22,000-23,000 pounds, as compared to an example direct-coupled system having an overall length on the order of about 408 inches and a weight greater than about 70,000 pounds. In some implementations, methods are provided for constructing and deploying a power generation unit, including coupling the internal combustion engine to the gearbox, connecting the generator to the gearbox, and mounting the assembled equipment on a trailer for mobile operation.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings:

FIG. 1 provides a block diagram illustrating a system environment for power generation, in accordance with various embodiments of the present disclosure;

FIG. 2 provides a block diagram illustrating the computing device(s) 152 of FIG. 1, in accordance with various embodiments of the present disclosure;

FIG. 3 is an example power generation unit 175 of FIG. 1, in accordance with various embodiments of the present disclosure;

FIG. 4 is another view of the power generation unit 175 positioned for transport on a trailer, in accordance with various embodiments of the present disclosure;

FIG. 5 is a side elevational view of a mobile natural-gas-powered generator system mounted on a trailer, in accordance with various embodiments of the present disclosure;

FIG. 6 is a side elevational view of a mobile natural-gas-powered generator system mounted on a trailer, in accordance with various embodiments of the present disclosure;

FIG. 7 is a top plan view of a mobile natural-gas-powered generator system mounted on a trailer, in accordance with various embodiments of the present disclosure;

FIG. 8 is a perspective view of a trailer-mounted mobile generator system housed within an enclosed trailer having a roof vent opening, a rear vent opening, and an exterior control panel, in accordance with various embodiments of the present disclosure;

FIG. 9 is a side elevational view of an enclosed trailer carrying a mobile natural-gas-powered generator system with an exterior control panel, in accordance with various embodiments of the present disclosure;

FIG. 10 is a perspective view of an electric generator including an electrical terminal box mounted on a generator housing, in accordance with various embodiments of the present disclosure;

FIG. 11 is a perspective view of a gear train of a twin countershaft compound reduction gearbox configured to reduce input speed and increase output torque for driving a generator, in accordance with various embodiments of the present disclosure;

FIG. 12 illustrates an example internal combustion engine 160 used in an example power generation unit, in accordance with various embodiments of the present disclosure;

FIG. 13 illustrates an example user interface with monitored characteristics from the power generation unit, in accordance with various embodiments of the present disclosure; and

FIG. 14 illustrates a flare gas burn off that may be avoided or reduced using various embodiments of the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements.

Indeed, many modifications and other embodiments of the presently disclosed subject matter set forth herein will come to mind to one skilled in the art to which the presently disclosed subject matter pertains, having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising” are used in a non-exclusive sense, except where the context requires otherwise. Likewise, the term “includes” and its grammatical variants are intended to be non-limiting, such that recitation of items in a list is not to the exclusion of other like items that may be substituted or added to the listed items.

### I. Example Use Case

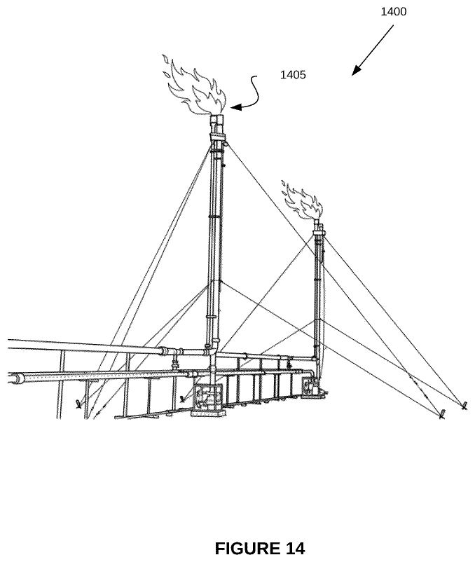

Flare gas is produced during oil collection and/or refinement processes. Usually, flare gas is flammable gas that is released via safety valves or other operations during the oil collection and refinement process. To avoid over-accumulation and explosions, the flare gas is often burned off via a gas flare burn off (shown in FIG. 14). While flare gas burn off promotes safety at an oil site, the burning of flare gas is not necessarily beneficial to the environment, resulting in unwanted emissions in addition to the inefficiencies due to burning gas that otherwise may have been used. As such, various embodiments of the present disclosure provide for a system that may use flare gas (as well as potentially other fuel sources) to provide remote power generation.

In addition to the benefits of using flare gas, various embodiments of the present disclosure also provide for a reduction in engine size required to produce a desired generator output. To do this, the internal combustion engine is coupled to a gearbox (e.g., a reduction gearbox) that converts the RPMs produced by the internal combustion engine for use by the generator. One or more sensors may be provided that monitor the operations of the power generation unit 175 in order to avoid any damage to any components, including the internal combustion engine, the gearbox, the generator, and/or the output device(s) receiving power from the generator. One or more computing device(s) may monitor the characteristics monitored and determine an operating condition status of the power generation unit. The computing device(s) may be able to adjust the power generation unit to improve output and/or efficiency. As a result, the efficiency of the system may be improved, while also reducing maintenance costs (e.g., by monitoring for any changes in the power generation unit that may cause damage or indicate maintenance is needed).

Power generation systems may be deployed to provide electrical power at locations where utility power is unavailable, insufficient, unreliable, or undesired. Example environments may include remote industrial operations, oil and gas field operations, construction sites, temporary power installations, data centers, and other infrastructure applications. In such environments, mobile generator sets may be transported to a site and operated to supply electrical loads that may be significant and continuous, for example three-phase power at a nominal voltage and frequency such as 480 Vac at 60 Hz, with continuous output on the order of hundreds of kilowatts to megawatts.

Conventional mobile generator sets capable of providing megawatt-class output often use an internal combustion engine directly coupled to an alternating-current generator such that the engine and generator rotate at a common speed. For example, generator sets intended to provide 60 Hz power are frequently operated at about 1800 revolutions per minute (RPM), and higher output levels may be pursued by selecting larger engines and generators. When high continuous power output is desired, such direct-coupled arrangements may lead to large and heavy packages that may be difficult to transport or deploy. In some cases, systems configured to generate about 1.2 to 1.5 MW may use an engine having a displacement on the order of 51 liters and a generator weighing on the order of 22,650 pounds, with overall packaged lengths on the order of 203 inches or more. Further, direct-coupled systems may be packaged at lengths on the order of 408 inches and weights on the order of 70,000 pounds or more, which may increase logistics costs and may lead to transport limitations, including the use of specialized towing equipment, commercial driver licensing, and/or permitting.

In additional embodiments, direct coupling may constrain engine operation to a generator speed that may not coincide with an engine speed associated with fuel efficiency, reduced emissions, and/or favorable torque production. For example, some engines may be configured to operate within an engine speed range such as 1800-2500 RPM (e.g., 1800-2200 RPM, 2200-2500 RPM, etc.) while a generator and its electrical output requirements may drive different rotational speed selections. Where direct coupling is employed, achieving a target electrical output may lead to the selection of a larger engine to meet torque demands, and may increase fuel consumption and emissions. These issues may be of particular concern for continuous duty operation and for systems expected to satisfy emissions requirements, for example, standards directed to NOx.

Advances in electrical machine technology may enable generators with increased power density and reduced size and weight relative to conventional machines. For example, generator technology using rare earth materials and other new materials and construction techniques may allow a generator to be smaller and lighter, and may allow the generator to reach a rated power output at relatively low rotational speeds, such as speeds as low as about 900 RPM. However, integrating such generator technology into a mobile generator set may present engineering considerations, including coupling a generator operating at a lower rotational speed to an internal combustion engine operating at a higher rotational speed, maintaining drivetrain efficiency, and packaging the drivetrain within a mobile form factor. In some implementations, a reduction gearbox may be used to provide a drive path from an engine to a generator while reducing speed and increasing torque, and the gearbox may be configured as a compound gearbox with a dual or twin countershaft configuration to support high reduction ratios in a compact footprint.

In some embodiments, mobile generator sets also benefit from electrical protection, power distribution, and control architectures that support field operation. For example, high-current electrical output may benefit from protective devices such as a multi-pole circuit breaker with time overcurrent and instantaneous trip protection, and from distribution hardware such as bus bars and grounding connections configured for field deployment. Generator sets may also be expected to operate in different operating modes, including a stand-alone mode and a utility synchronization mode, and achieving desired performance in such modes may involve controlling the rate of load application and managing synchronization. Local operator interfaces and remote monitoring and/or remote operation may be desirable, for example, via a local human-machine interface, a communication interface (e.g., a J1939 communication interface), a networked data link, and/or the like. In additional embodiments, fuel supply and maintenance considerations may influence deployment, and a generator system may benefit from flexibility with respect to fuel type and fuel supply conditions, for example, operation on natural gas or methane with supply pressure within a range such as about 60 to 150 psi and with methane content at or above a minimum content such as about 65%, and/or operation on diesel with an on-board fuel tank. Auxiliary equipment such as heaters, battery charging equipment, anti-condensation heating, fire suppression equipment, multiple emergency stop access points, and oil level maintenance may also support field reliability and serviceability.

Various embodiments of the present disclosure provide a mobile power generation system that addresses one or more of the foregoing considerations by combining an internal combustion engine, a reduction gearbox, a generator, and integrated controls in a compact package configured for high continuous power output. In some embodiments, the system may provide about 900 to 1100 kW continuous at about 480 Vac and about 60 Hz, and may include a 15 liter, six-cylinder internal combustion engine selected from a natural gas/methane engine or a diesel engine. A natural gas engine may be compressed natural gas or liquefied natural gas (e.g., selected based on usage type, application, fuel availability, and/or the like).

The engine may be coupled to the generator through a high reduction ratio compound gearbox having a parallel-axis, twin countershaft configuration, in which the gearbox provides speed reduction and torque multiplication, for example, a reduction ratio of about 2.5:1 with torque multiplication up to about 2.5:1. In an illustrative operating point, the gearbox may receive about 2500 lb-ft at about 2200 RPM and may output about 6111 lb-ft at about 900 RPM with an efficiency on the order of about 95%. The gearbox may include a gear train having multiple meshing spur gears on parallel shafts, and example gearbox implementations may include primary gears of about 9 inches by about 2.5 inches and centerline spacing of about 7 inches within an example physical envelope of about 32 inches in width, about 19 inches in height, and about 28 inches in length.

In some embodiments, the generator may comprise a three-phase generator having a rated power on the order of about 1500 kW and configured for nominal 480 Vac, 60 Hz output, with generator rotational speeds including about 900 RPM and/or about 1200 RPM, and the generator may include brushless excitation, voltage regulation, and power quality and overload characteristics such as total harmonic distortion (e.g., less than about 3.5% at full load), overload capability (e.g., about 110% for one hour), overload capability (e.g., 300% for about 20 seconds), and/or the like.

In various embodiments, the system may include integrated engine and generator communications and controls that control a rate of load application and synchronization, including a stand-alone mode and a utility synchronization mode, and the controls may include a custom human-machine interface, a communication interface (e.g., a J1939 interface for communications), and/or a networked data link for remote monitoring and operation. In some embodiments, the system may include electrical output protection and distribution hardware including a 4000 amp, 3-pole circuit breaker with time overcurrent and instantaneous trip protection, and NEMA standard full-rated bus bars and ground connection, along with auxiliary equipment including a jacket water heater, an on-board battery charger, a generator anti-condensation heater, an on-board fire suppression system, integrated multiple emergency stop access, and an optional lube oil make-up reservoir configured to maintain crankcase oil level. In some embodiments, the system may include a diesel configuration having an on-board fuel tank, for example, a 250 gallon on-board fuel tank. In some embodiments, the system may be mounted on a trailer or packaged within an enclosed trailer, and example packaged configurations may have an overall length on the order of about 172 inches and a weight of around 22,000-23,000 pounds (e.g., an example power generation unit may be 22,650), thereby supporting transport by a 1 ton truck without commercial driver licensing or permitting in at least some implementations. The size and weight of the power generation unit may vary based on components selected (e.g., the overall length may be between 110-250 inches and the weight may be 15,000 to 30,000 pounds).

In some embodiments, the mobile power generation system is configurable to support multiple deployment configurations, including selectable electrical output voltage, selectable natural gas supply arrangements, and local and/or remote monitoring and control via integrated engine and genset controls.

In some embodiments, the power generation unit is configurable to provide three-phase alternating-current output at different nominal voltages. For example, the generator and associated output distribution equipment may be configured for operation at a first nominal line-to-line voltage of about 480 Vac and, alternatively, at a second nominal line-to-line voltage of about 415 Vac. Voltage selection may be established at manufacture, commissioning, and/or deployment based on a target load requirement and/or an interconnection requirement. When configured for a selected nominal voltage, the system may correspondingly configure or select voltage regulation settings and an output protection configuration suitable for the selected nominal voltage, including an output circuit breaker and output bus bars. In some embodiments, the output protection includes a multi-pole circuit breaker, such as a 4000 amp, 3-pole circuit breaker having time overcurrent and instantaneous trip protection, and the output distribution includes NEMA standard, full-rated bus bars and a ground connection.

In some embodiments, when configured for natural gas operation, the internal combustion engine is supplied from a natural gas source stored and transported as compressed natural gas (CNG) or as liquefied natural gas (LNG). In such embodiments, selection of CNG or LNG may be based on application-specific factors such as usage type, application, and/or fuel availability. In some embodiments, regardless of how the natural gas is stored upstream of the power generation unit, a fuel-supply interface of the power generation unit is configured to receive natural gas at an engine inlet pressure suitable for rated operation. For example, the fuel-supply interface may be configured to receive natural gas within a supply pressure range of about 60 psi to about 150 psi. In some embodiments, the natural gas has a methane content of at least about 65%, with corresponding reduction in output under lower methane-content conditions. Upstream equipment external to the power generation unit may be used, as applicable, to provide the natural gas to the fuel-supply interface at the specified inlet pressure.

In some embodiments, the power generation unit includes integrated engine and genset communications and controls configured to control a rate of load application and to control synchronization, including stand-alone operation and utility-synchronization operation. The integrated controls may include a local human-machine interface (HMI) that displays engine and genset parameters, and a communication interface such as a J1939 interface for communication between control modules and subsystems. In some embodiments, the integrated controls include a networked data link for remote monitoring and operation. The networked data link may communicate via a wired or wireless network, including a wireless internet connection, to one or more remote computing devices, thereby supporting remote monitoring and, in some embodiments, remote start and stop of the power generation unit. In some embodiments, the networked data link further supports remote adjustment of one or more operating parameters associated with fueling of the internal combustion engine (e.g., a fuel-related setpoint, limit, or calibration parameter), while maintaining coordinated control of load-application rate and, when applicable, synchronization.

The generator may be implemented using different electrical machine technologies. In some embodiments, the generator comprises a brushless-excitation alternator, such as a generator having brushless excitation and an associated voltage regulator configured to regulate output voltage. In other embodiments, the generator comprises a permanent magnet machine operated as a generator, in which a rotor permanent magnet structure provides a magnetic field without a separately excited main field winding. In some embodiments, generator technology uses rare earth materials and/or other new materials and construction techniques to provide increased power density and reduced size and weight relative to conventional systems, and to facilitate rated power output at comparatively low generator rotational speed. Accordingly, references herein to a permanent magnet generator and references herein to a brushless-excitation generator are intended to describe alternative generator implementations usable within the disclosed engine-gearbox-generator architecture.

Generator configuration (pole count and/or frequency conditioning) may be selected to provide a specific frequency (e.g., 60 Hz) at the specified generator speed. For alternating-current generation, electrical output frequency is related to generator rotor speed and pole count. In a synchronous generator implementation, the electrical frequency f (Hz) is related to rotor speed N (rpm) and pole count P by f=(P*N)/120. By way of example, a 4-pole synchronous generator provides 60 Hz output at about 1800 rpm, a 6-pole synchronous generator provides 60 Hz output at about 1200 rpm, and an 8-pole synchronous generator provides 60 Hz output at about 900 rpm. In some embodiments described herein, the generator is operated at a generator rotational speed of about 900 rpm and/or about 1200 rpm, and the generator configuration (including pole count) is selected so that the generator provides a desired output frequency (e.g., about 60 Hz) at the selected generator rotational speed. References herein to generator operation at about 1000 rpm represent an example low-speed operating point for certain generator configurations, and the generator configuration and operating point may be selected in coordination with the reduction gearbox and engine operating speed to achieve desired electrical output characteristics.

Unless expressly stated otherwise for a particular embodiment, features such as dual-voltage operation, selection of CNG or LNG supply, remote start/stop, and remote fuel adjustment are optional and may be implemented individually or in combination. Additionally, where embodiments are described in terms of functional capabilities (e.g., receiving a gaseous fuel within a specified pressure range, providing remote monitoring and operation via a networked data link, or providing a selected nominal output voltage), the particular hardware arrangements used to realize those capabilities may vary based on application-specific requirements and are not limiting.

In some embodiments, the mobile power generation systems described herein may incorporate one or more technical features that may distinguish the present disclosure from conventional direct-coupled generator sets, including features directed to drivetrain configuration, packaging, generator technology, integrated controls, electrical protection, and fuel flexibility.

For example, one or more implementations may include a compact, mobile, megawatt-class generator set that couples a higher-speed internal combustion engine to a lower-speed generator using a high reduction ratio, parallel-axis, twin/dual countershaft compound gearbox providing torque multiplication up to about 2.5:1 at a drivetrain efficiency on the order of about 95%; a packaging arrangement that materially reduces overall system length and weight relative to direct-coupled megawatt-class generator sets, for example, an overall length of about 172 inches and a weight of less than about 22,000 pounds, as compared to an overall length of about 408 inches and a weight of more than about 70,000 pounds, thereby enabling towing and deployment advantages for field operations, including transport by a 1 ton truck in at least some implementations; integration of a high power-density generator technology, including use of rare earth materials and construction techniques enabling rated power at generator rotational speeds as low as about 900 RPM, and, in some implementations, a generator that is about one-third the size and weight of conventional systems, with the reduction gearbox to achieve high continuous electrical output in a smaller package; a controls and communications package integrated across the internal combustion engine and the generator set, the controls and communications package configured to control a rate of load application and to control synchronization, including support for stand-alone and utility-synchronization modes, and including a local human-machine interface and a networked data link for remote monitoring and operation, optionally via a communication interface (e.g., a J1939 communication interface); a field-deployable electrical output and protection subsystem integrated into the mobile package, including a 4000 amp 3-pole circuit breaker with time overcurrent and instantaneous trip protection and NEMA standard full-rated bus bars and a ground connection, together with auxiliary systems including a jacket water heater, an on-board battery charger, a generator anti-condensation heater, an on-board fire suppression system, and integrated multiple emergency-stop access; flexible fuel embodiments including operation using methane with supply pressure of about 60 psi to about 150 psi and minimum methane content of about 65% and/or operation using diesel fuel, including a diesel configuration having a 250 gallon on-board fuel tank, and an optional lube oil make-up reservoir configured to maintain crankcase oil level and extend maintenance intervals; and/or the like. Any of the foregoing features may be implemented individually or in any suitable combination.

### II. With Reference to the Figures

Reference will now be made in detail to aspects of the disclosure, examples of which are illustrated in the accompanying drawings. The following description refers to the accompanying drawings in which the same numbers in different drawings represent the same or similar elements unless otherwise represented. The implementations set forth in the following description do not represent all implementations consistent with the disclosure.

Instead, they are merely examples of apparatuses and methods consistent with aspects related to the disclosure as recited in the appended claims. Particular aspects of the present disclosure are described in greater detail below. The terms and definitions provided herein control, if in conflict with terms and/or definitions incorporated by reference.

Systems, methods, and apparatuses are described herein that relate generally to a system for power generation. In the following description, for purposes of explanation, numerous specific details are set forth to provide a thorough understanding of the present disclosure. It will be evident, however, to one skilled in the art that the present disclosure may be practiced without these specific details and/or with any combination of these details.

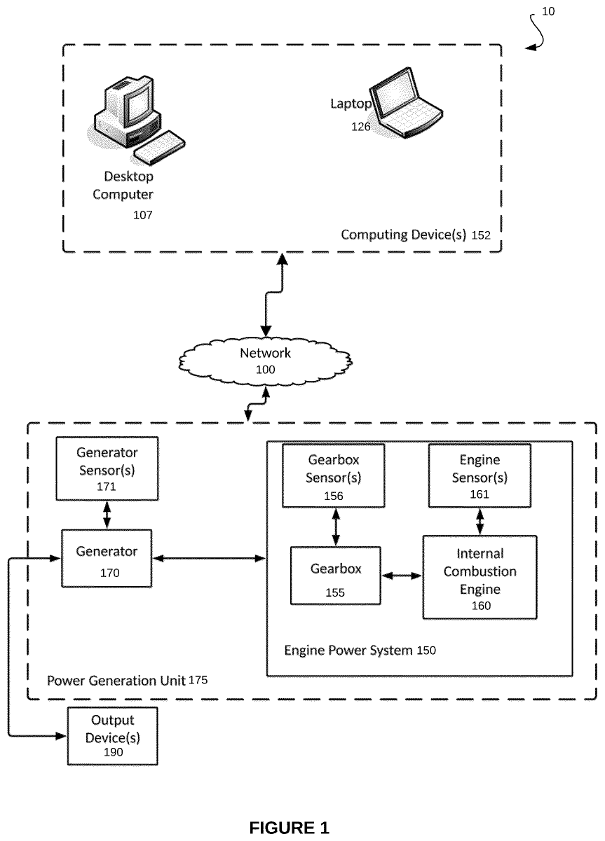

Referring now to FIG. 1, a block diagram illustrating a system environment 10 (“system”) for power generation, in accordance with various embodiments, is provided. The system includes computing device(s) 152 and a power generation unit 175 connected to a network 100. As shown, the computing device(s) 152 (e.g., desktop computer 107, laptop 126, and/or the like) associated with users are in communication with network 100. The power generation unit 175 is also in communication with the network 100. In various embodiments, the connection with the network 100 may be secured (e.g., via encryption or other security measures) to allow for remote communication between components.

The power generation unit 175 includes an engine power system 150 (e.g., a gearbox 155 operably coupled to an internal combustion engine 160) and a generator 170. The gearbox 155 may be a gearbox (e.g., a reduction gearbox). The generator 170 may receive power from the engine power system 150 and transmit said power safely to output device(s) 190. An output device may be any device that receives electrical power.

Various sensors may monitor characteristics relating to the power generation unit 175. For example, gearbox sensor(s) 156 may monitor characteristics relating to the gearbox 155, engine sensor(s) 161 may monitor characteristics relating to the internal combustion engine 160, and/or the generator sensor(s) 171 may monitor characteristics relating to the generator 170. Any number of different sensors may be used. The sensor(s) may communicate directly with the network 100 and/or be connected to a communication interface (e.g., a controller that is part of the power generation unit 175). Example sensor(s) and monitored characteristics are discussed in more detail herein.

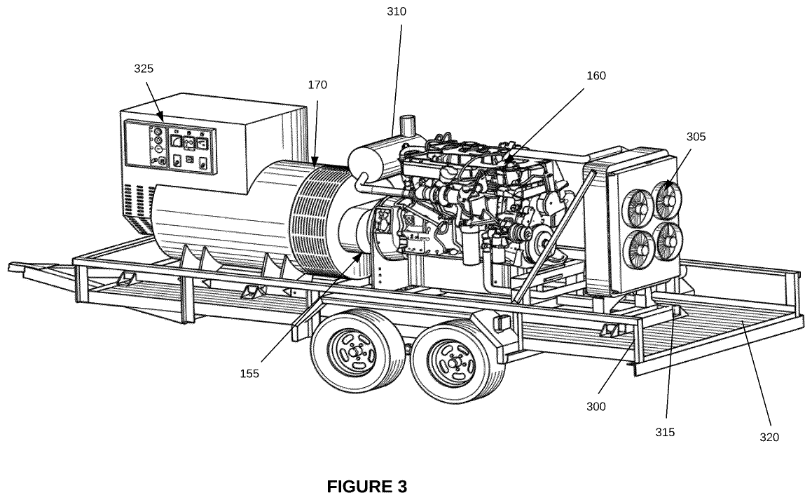

The various components of the power generation unit 175 are further discussed in reference to FIGS. 3-12 below. In various embodiments, the power generation unit 175 may include an engine power system 150 (including an internal combustion engine 160 and a gearbox 155) and a generator 170. The generator 170 may receive power from the engine power system 150 and distribute electricity to one or more output device(s) 190. The output device(s) 190 may be any electrical component that may be connected to a power source (e.g., any device that uses power upon connection). For example, the output device(s) 190 may include gas field equipment for use in a gas field use case.

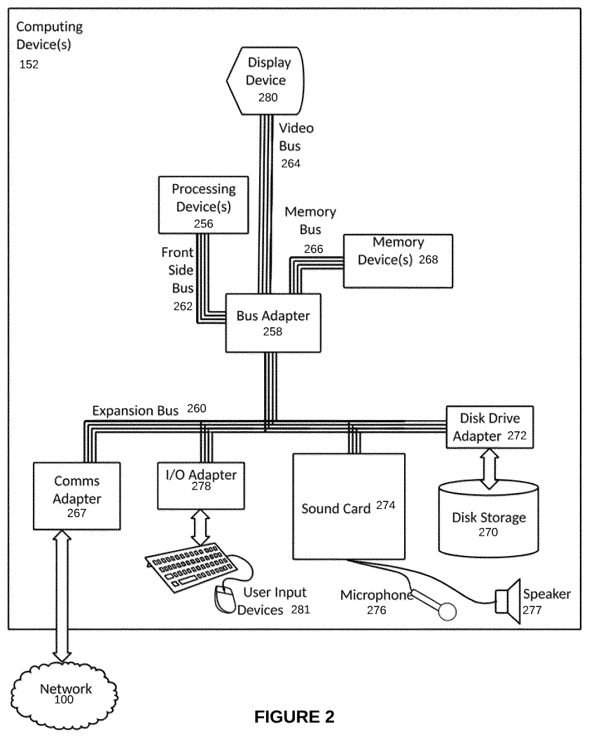

Referring now to FIG. 2, a block diagram illustrating the computing device(s) 152 of FIG. 1, in accordance with various embodiments, is provided. FIG. 2 is merely an illustrative example of computing device(s) 152. Various types of computing device(s) 152 may be used or otherwise contemplated for the system. The computing device(s) 152 may be part of the power generation unit 175 (e.g., connected directly and/or housed on the unit). Additionally or alternatively, one or more of the computing device(s) 152 may be remote from the power generation unit 175. For example, the computing device(s) 152 may allow the power generation unit 175 to be operated remotely.

Example computing devices include desktop computers 107, mobile devices, such as mobile phones, tablets, smart watches, etc., laptops 126, and/or the like. As such, the computing device(s) 152 may be any device that is capable of performing the operations discussed herein. For example, a mobile phone may include communication interfaces to communicate with mobile networks and local area networks (e.g., via Wi-Fi).

The computing device(s) 152 of FIG. 2 includes one or more processing devices 256, one or more memory devices 268, a display device 280, a communication adapter 267, an input/output adapter 278, and a disk drive adapter 272. In various embodiments, the various components may be connected to one another via a BUS adapter 258 (e.g., the processing device(s) 256 may be attached via a front side BUS 262, the memory device(s) 268 may be attached via a memory BUS 266, the display device 280 may be attached via a video BUS 264, and the communication adapter 267, I/O adapter 278, disk drive adapter 272, and/or other interfaces may be attached via expansion BUS 260).

It should be understood that the memory device(s) 268 may include one or more databases or other data structures/repositories. The memory device 268 also includes computer-executable program code that instructs the processing device(s) 256 to operate the network communication interface (e.g., communication adapter 267) to perform certain communication functions of the system described herein.

Some embodiments of the computing device(s) 152 include processing device(s) 256 communicably coupled to such components as the memory device(s) 268, the communication adapter 267, the input/output adapter 278, the disk drive adapter 272, and/or the like. The processing device(s) 256, and other processors described herein, generally include circuitry for implementing communication and/or logic functions of the system. For example, the processing device(s) 256 may include a digital signal processor device, a microprocessor device, and various analog to digital converters, digital to analog converters, and/or other support circuits. Control and signal processing functions of the computing device(s) 152 are allocated between these devices according to their respective capabilities. The processing device(s) 256 thus may also include the functionality to encode and interleave messages and data prior to modulation and transmission. The processing device(s) 256 may additionally include an internal data modem. Further, the processing device(s) 256 may include functionality to operate one or more software programs, which may be stored in the memory device(s) 268. For example, the processing device(s) 256 may be capable of operating a connectivity program to communicate via the communication adapter 267.

The processing device(s) 256 are configured to connect to the network 100 via the communication adapter 267 to communicate with one or more other devices on the network 100. In this regard, the communication adapter 267 may include various components, such as an antenna operatively coupled to a transmitter and a receiver (together, a “transceiver”). The processing device(s) 256 are configured to provide signals to and receive signals from the transmitter and receiver, respectively. The signals may include signaling information in accordance with the air interface standard of the applicable cellular system of the network 100. In this regard, the computing device(s) 152 may be configured to operate with one or more air interface standards, communication protocols, modulation types, and access types. By way of illustration, the computing device(s) 152 may be configured to operate in accordance with any of a number of first, second, third, fourth, and/or fifth-generation communication protocols, and/or the like.

The I/O adapter 278, which allows the computing device(s) 152 to receive data from a user, such as a system administrator, may include any of a number of devices allowing the computing device(s) 152 to receive data from the user, such as a keypad, keyboard, touch-screen, touchpad, microphone, mouse, joystick, other pointer device, button, soft key, and/or other input device(s). The user interface may also include a camera, such as a digital camera.

The disk drive adapter 272 may provide additional storage space via disk storage 270. Various other storage mediums may also be used by the computing device(s) 152, such as cloud storage (e.g., transmitted via the communication adapter 267).

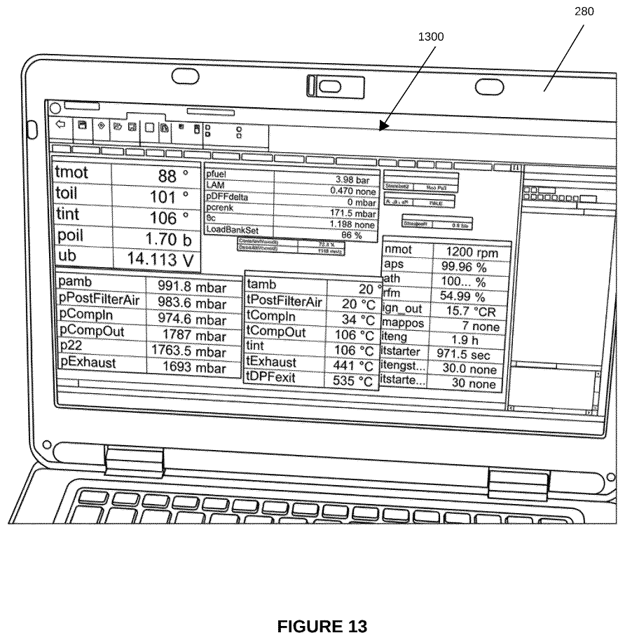

As described above, the computing device(s) 152 have a user interface that is rendered via the display device 280. The display device 280 includes a display (e.g., a liquid crystal display or the like) and/or a speaker or other audio device, which are operatively coupled to the processing device(s) 256. As such, the user interface 1300 of FIG. 13 (and any other user interfaces contemplated herein) discussed herein may be provided to the computing device(s) 152 via the display device 280 (e.g., visually via the user interface and/or audibly via the speaker or other audio device). In various embodiments, the display device 280 may be in communication with a sound card 274 (e.g., attached to a microphone 276 and/or a speaker 277 (e.g., the speaker 277 may be part of the display device 280 or standalone)).

Referring now to FIGS. 3-7, an example power generation unit 175 is shown from various different views. The power generation unit 175 includes an internal combustion engine 160, a gearbox 155, and a generator 170. The power generation unit 175 may be a self-contained, mobile unit that allows the unit to be moved to different areas for operation. The power generation unit 175 may be modular, allowing components to be interchanged. The power generation unit 175 may be housed within a frame 300. The frame 300 may include components to allow for the power generation unit 175 to be moved (e.g., the frame aperture(s) 315 provide for a forklift or other lifting mechanism to engage and move the power generation unit 175).

In various embodiments, the power generation unit 175 may be mobile, carried by a truck and/or trailer. For example, the power generation unit 175 may be mounted on a trailer 320 and carried by a truck (e.g., a medium duty truck). An example power generation unit 175, such as the system shown in FIGS. 3-7, may be approximately 20,000 lbs. The weight may be based on the selected components (e.g., engine, gearbox, generator, etc.), however generally the power generation unit 175 may be transported via a trailer to a location for use.

The power generation unit 175 may include various components to assist the operations of the internal combustion engine 160, the gearbox 155, and/or the generator 170. The generator 170 (and/or other components) may have on-board electronics (e.g., control panel 325 that includes at least a portion of the electronics discussed in reference to FIG. 1 above). The control panel 325 may include any of the components of the computing device(s) 152 discussed herein. Example components of the power generation unit 175 include fuel conditioning and filtration, engine cooling, lubrication, exhaust/emission controls, load management and synchronization, and/or the like. Each component may be housed within the frame 300 to allow for transport.

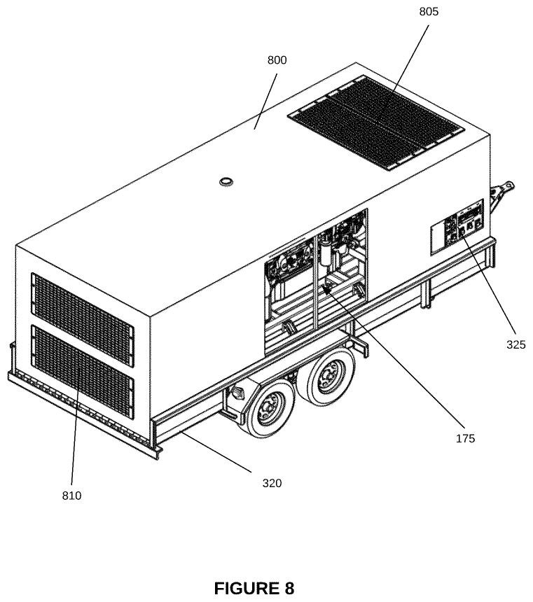

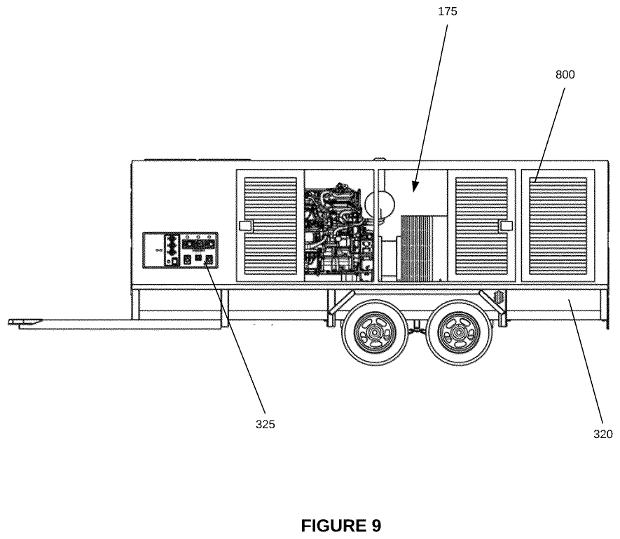

The power generation unit 175 may include cooling components 305 (e.g., fan(s), radiator devices, and/or the like). The cooling components 305 may be used to cool the internal combustion engine during operation. As shown in FIGS. 3-7, the frame may open to allow airflow to also provide a cooling effect to the internal combustion engine 160 (e.g., in a cooler and/or windy climate). Alternatively, the frame 300 may have walls (e.g., as shown in FIGS. 8 and 9) to provide protection from outside conditions. The cooling components may provide liquid (e.g., water, antifreeze, etc.) and/or air-cooling.

The power generation unit 175 may also include exhaust components 310. The exhaust components 310 may be connected to the internal combustion engine 160 to remove exhaust fumes. In various embodiments, the exhaust components 310 may include catalytic converter(s) and/or other exhaust scrubbing device(s) to reduce the emissions from the power generation unit 175.

Any number of internal combustion engine(s) may be used for the internal combustion engine 160. In various embodiments, the internal combustion engine 160 may be structured to operate on one or more fuel types (e.g., methane, natural gas, gasoline, diesel, methane H2S, etc.). In various embodiments, the internal combustion engine 160 may be specifically designed for a specific type of gas power. For example, the internal combustion engine 160 may be designed to run on methane gas (e.g., methane gas found in flare gas). The internal combustion engine 160 may be operated on various types of fuels, such as flare gas, wellhead/production gas, pipeline gas, and/or the like.

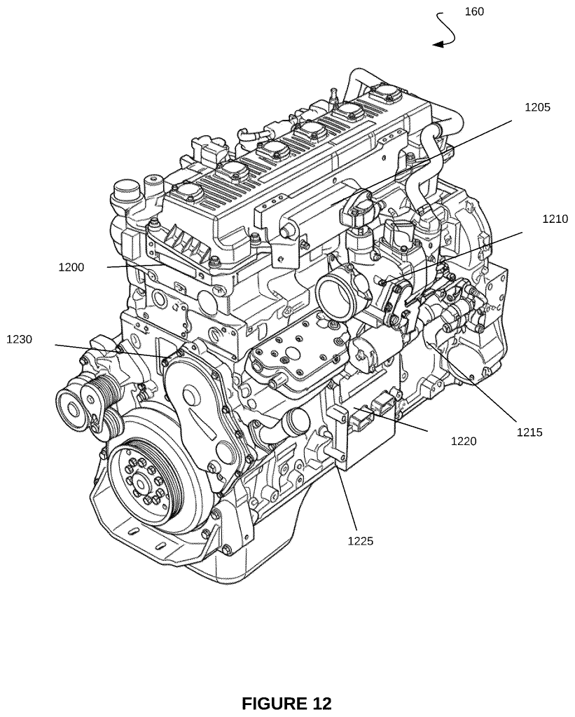

An example internal combustion engine 160 is shown in FIG. 12. The internal combustion engine 160 shown in FIG. 12 is a natural gas fueled engine. Example natural gas fueled engines used in various embodiments include a Cummins ISX12, which is an 11.9 liter, natural gas fueled engine, a Cummins X15N, and/or the like. A number of different internal combustion engines may be used for the various applications. For example, an internal combustion engine may be a diesel engine, a natural gas engine, a gasoline engine, and/or the like. The interchangeability allows for the power generation unit 175 to be used with various different components. For example, a user may desire to use a different internal combustion engine more familiar. As a result, the power generation unit 175 may be designed based on the desired engine (e.g., engine power) and the desired output for the generator.

An example internal combustion engine 160 may be a 15 liter methane fueled engine that is tuned to run on methane supply (e.g., recycling flare gas). Such an example may have a pressure minimum of 65 PSI, with a nominal 80% methane content (that could run as low as 65% with corresponding reduction in output to the gearbox). Such an example internal combustion engine may be capable of outputting 3000 Nm of torque at 2300 RPM with a fuel consumption of approximately 98 cubic meters per hour of methane.

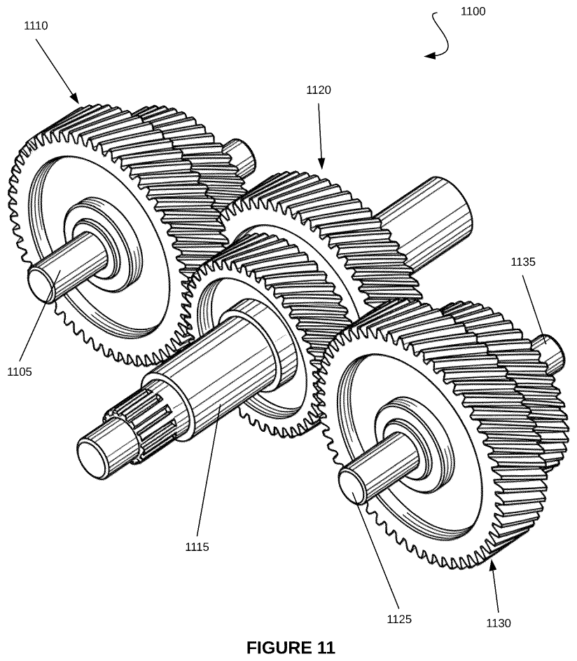

The internal combustion engine 160 is operably connected to the gearbox 155. The gearbox 155 may be a reduction gearbox (e.g., example gears 1100 are shown in FIG. 11 that are used in a gearbox 155). The gearbox 155 may be geared to convert a higher RPM produced by the internal combustion engine 160 into a lower RPM, thereby providing power to the generator 170. The gear ratio of the gearbox may be based on the input RPM of the internal combustion engine 160 and the desired output RPM for the generator.

In various embodiments, example gear ratios (also referred to as reduction ratios) for the gearbox may range from 1.1:1 to 7:1. In various embodiments, example gear ratios for the gearbox may range from 1.1:1 to 5:1. In various embodiments, example gear ratios for the gearbox may range from 1.5:1 to 5:1. In various embodiments, the gearbox 155 may have a gear ratio between 2:1 and 4:1. In various embodiments, the gearbox 155 may have a gear ratio between 2:1 and 3:1. In various embodiments, the gearbox 155 may have a gear ratio between 2:1 and 2.5:1. In various embodiments, the gearbox 155 may have a gear ratio of approximately 2.5:1. In various embodiments, the gearbox 155 may have a gear ratio of approximately 2.3:1.

The reduction ratio may be sufficient to allow for the RPM output by an internal combustion engine to be reduced via the gearbox 155 before being supplied to the generator 170 at a target RPM (with increased torque). In various embodiments, gearbox receives an input torque at an input speed from the internal combustion engine and outputs an output torque at an output speed to the generator. The output torque is higher than the input torque based on the reduction ratio and an efficiency of the gearbox.

The gear ratio may be based on the RPM generated by the internal combustion engine 160 and the desired RPM input for the generator 170. For example, the gear ratio may be tuned to convert the RPM generated by the internal combustion engine 160 into the desired RPM for the generator 170. For example, a 1500 RPM internal combustion engine 160 may be converted for coupling to a 1000 RPM generator via the gearbox 155 (e.g., using a 1.5 gear ratio). Moreover, the torque produced may be changed inversely to the change of RPMs. For example, the torque may increase in an instance in which the RPMs are slowed using the gearbox 155 discussed herein. In an example embodiment, the gearbox 155 may have a reduction ratio of 2.3:1. For example, the gearbox 155 may convert 3000 Nm of torque at 2300 RPM from the internal combustion engine 160 into 6900 Nm at 1000 RPM for the generator 170.

The internal combustion engine 160 and the gearbox 155 may collectively be referred to as the engine power system 150. The engine power system 150 is responsible for generating the power to be provided to the generator 170. The generator 170 may receive a transfer of power from the engine power system 150. The generator 170 may be capable of storing and/or transmitting the power to output device(s) 190 (shown in FIG. 1). The output device(s) 190 may be any device that receives electricity from the generator 170.

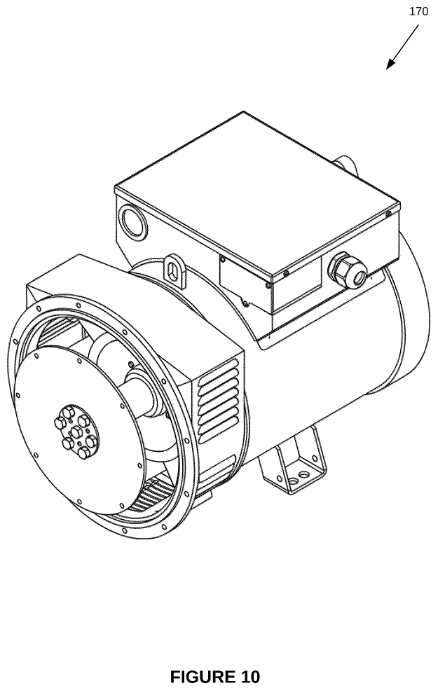

In various embodiments, the generator 170 may be any number of different kinds of generator(s) 170. As discussed herein, any number of different kinds of generator and/or different sized generators may be used. For example, the generator 170 may be a 1.5-megawatt (Mw) generator (e.g., a 1.5 Mw permanent magnet generator). The size of the generator 170 may be based on the size of the internal combustion engine 160 and/or the gear ratio of the gearbox 155. For example, a 1.2-1.5 Mw generator (e.g., an example generator 170 is shown in FIG. 10) may be used with the internal combustion engine 160 shown in FIG. 12. An example generator 170 may have any number of poles. For example, the generator 170 may be a 4 pole or 6 pole generator (e.g., maximum rated electrical power of 1500 Kw with input power at 10,000 Nm).

Any number of components of the power generation unit 175 may be controlled and/or monitored via a controller. The controller may be unitary to the given component (e.g., the internal combustion engine 160 may have an on-board CPU) and/or the controller may be part of the computing device(s) 152. The controller allows the power generation unit 175 to be monitored and/or controlled.

In various embodiments, the controller may allow the internal combustion engine 160 to operate on different fuel sources, such as flare gas or other gas sources. In various embodiments, the power generation unit 175 and/or the computing device(s) 152 may monitor one or more fuel characteristics of the fuel to determine operating conditions for the power generation unit 175. The fuel characteristics may determine the operating parameters of the power generation unit 175. For example, the power generation unit 175 and/or the computing device(s) 152 may monitor the fuel characteristics (e.g., methane content) within flare gas to determine whether the methane content meets a minimum methane content to operate the internal combustion engine 160. In such an example, the one or more engine sensor(s) 161 discussed in reference to FIG. 1 may include gas sensor(s) that monitor the gas before and/or during introduction to the internal combustion engine 160. In various embodiments, the system may determine, via at least one engine sensor, the methane content (or other gas content) within the gas to be used to power the internal combustion engine.

In various embodiments, the operating conditions of the power generation unit 175 may be changed based on the fuel characteristic(s). For example, in an instance in which the methane content is less than a minimum methane content, the system may be turned off and/or use an auxiliary fuel source. In an instance in which the methane content is within an acceptable range, the system may determine the output by the internal combustion engine 160 based on the fuel characteristic(s) (e.g., the amount of methane in the fuel may indicate the efficiency of the internal combustion engine 160). The operations may be completed remotely (e.g., via the computing device(s) 152) and/or within the power generation unit 175.

The engine sensor(s) 161 may also monitor various different characteristics of the internal combustion engine 160 before, during, and/or after power generation. Example characteristics monitored by the system (via the engine sensor(s) 161) include fuel characteristics, firing order and/or firing timing of the internal combustion engine 160, RPMs of the internal combustion engine 160, engine temperature, cylinder temperature(s), various component temperature(s), input/output pressures, filter restrictions, and/or the like. In various embodiments, any number of engine sensors may be used to capture the characteristics. The characteristics may be used to monitor and/or adjust the power generation unit 175.

The gearbox 155 and/or the generator 170 may also have sensor(s) for monitoring before, after, and/or during operations. For example, the gearbox 155 may have one or more gearbox sensor(s) 156 for monitoring operations relating to the gearbox 155. The generator 170 may also include one or more generator sensor(s) 171 for monitoring operations relating to the generator 170. Example characteristics relating to the generator that may be captured (e.g., via the generator sensor(s) 171) include outputs of the generator (e.g., frequency (e.g., a desired frequency may be between 50 and 60 hertz), voltage, excitation, etc.), output RPMs, bearing temperature, breaker position, current, and/or the like. The characteristics determined via the gearbox sensor(s) 156 and/or the generator sensor(s) 171 may be used to monitor and/or adjust the power generation unit 175.

In various embodiments, in an instance in which the operations are outside of a desired operating parameter (e.g., a characteristic monitored relating to the power generation unit 175 is outside of an expected range), the system may perform one or more correction actions. For example, the system may change operating conditions in an instance in which the fuel characteristics of the fuel source are outside of a desired range. Additionally or alternatively, the system may cease operation in an instance in which an error is determined. For example, the system may determine a characteristic that is outside of the operating parameters and cause the power generation unit 175 to power off until the issue is investigated and/or fixed. In various embodiments, an error code may be generated without stopping operation (e.g., allowing for continued use). In various embodiments, the severity of the error may determine whether the power generation unit continues operation.

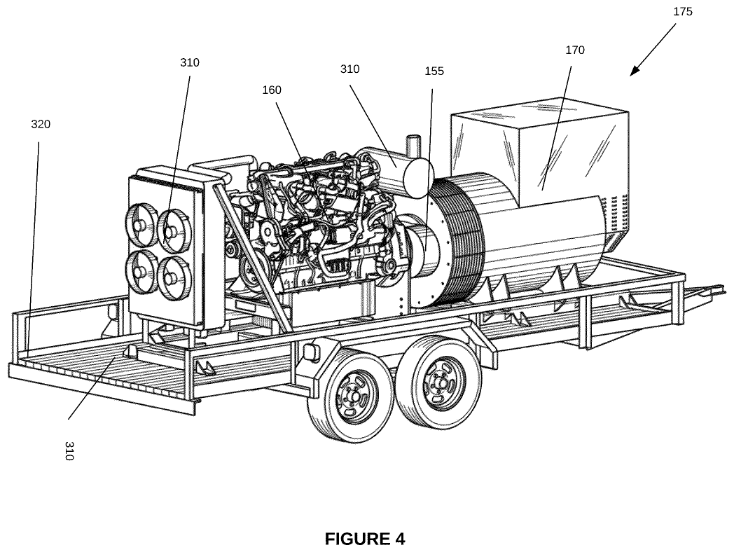

In various embodiments, the power generation unit 175 may be operated remotely. For example, a power generation unit 175 (as shown in FIGS. 3 and 4) may be delivered to an operation location, connected to a fuel source, and then operated remotely (e.g., via computing device(s) 152). Additionally or alternatively, the power generation unit 175 may include processing device(s) and/or memory device(s) that allow the power generation unit 175 to be operated onsite. For example, the power generation unit 175 may include component(s) of the computing device(s) 152 to allow for the power generation unit 175 to be operated onsite (e.g., in an instance in which the power generation unit 175 is not connected to the network 100). In various embodiments, a computing device(s) 152 may be capable of directly coupling to the power generation unit 175 (e.g., via a local connection).

In various embodiments, the frame 300 carries an internal combustion engine 160 operably coupled to a generator 170 through a gearbox 155, and further supports cooling components 305, an exhaust component 310, and a control panel 325. In some embodiments, the mobile generator system is configured to supply three-phase alternating current (e.g., nominal 480 Vac at 60 Hz) at a continuous power level on the order of about 900 kW to about 1100 kW, while remaining transportable as an integrated trailer-mounted package.

In the illustrated embodiment, the internal combustion engine 160 provides a prime mover for the generator 170 and may be implemented as a spark-ignited natural-gas/methane engine (e.g., a 15-liter, six-cylinder engine such as a Cummins X15N) configured to receive a gaseous fuel supply. For example, the engine 160 may be configured for operation with natural gas/methane supplied at about 60 psi to about 150 psi and with a methane content of at least about 65%, although other fuel supply conditions may be used. The engine 160 may be mounted to the frame 300 via vibration-isolation mounts and may include associated accessories (e.g., intake, ignition, and engine control hardware), not shown in detail in FIG. 3.

The gearbox 155 mechanically couples an output of the engine 160 to an input of the generator 170 and may be configured as a reduction gearbox that decreases rotational speed while increasing torque. In some embodiments, the gearbox 155 comprises a compound gear train having a parallel-axis, twin countershaft configuration providing a reduction ratio of about 2.5:1 and a drivetrain efficiency on the order of about 95%. By way of example, the gearbox 155 may receive approximately 2500 lb-ft at approximately 2200 RPM and may output approximately 6111 lb-ft at approximately 900 RPM, thereby enabling the engine 160 to operate at an engine speed suitable for torque production while driving the generator 170 at a lower generator speed.

The generator 170 is coupled to the gearbox 155 and converts the delivered mechanical power into electrical output delivered through the control panel 325. In various embodiments, the generator 170 may be an AC alternator generator (e.g., an industrial AC alternator generator). For example, the generator 170 may include an alternator (e.g., a three-phase alternator) having brushless excitation and regulation circuitry configured to maintain an output voltage and frequency within specified limits. An example generator 170 may be a Meccalte ECO46-class generator having a rated power on the order of about 1500 kW. The exact brand and power rating of the generator 170 may vary based on desired amount of power generation. The generator 170 may be implemented using high power-density construction (e.g., incorporating rare earth materials and/or other advanced materials) to provide rated power at comparatively low generator speed, such as at about 900 RPM and/or about 1200 RPM, by selection of an appropriate pole count and regulation strategy.

The cooling components 305 are positioned adjacent the engine 160 and may include one or more heat exchangers and forced-air devices (e.g., fans) configured to reject heat from one or more thermal circuits of the mobile generator system. For example, the cooling components 305 may include a radiator and fan array configured to cool engine jacket water, and may additionally cool charge air, lube oil, and/or coolant associated with the generator 170 or gearbox 155. The location of the cooling components 305 at an end region of the frame 300 may facilitate airflow management and service access in a trailer-mounted implementation.

The exhaust component 310 is coupled to the engine 160 to conduct exhaust gases away from the engine 160 and may include one or more acoustic attenuation and/or emissions control devices. In some embodiments, the exhaust component 310 includes a muffler and an outlet conduit routed to a selected discharge location relative to the trailer 320. In further embodiments, the exhaust component 310 may include an aftertreatment device (e.g., a catalyst) selected to meet applicable emissions requirements.

The control panel 325 is mounted proximate the generator 170 and may house electrical distribution and protection components and control electronics for coordinated operation of the engine 160, gearbox 155, and generator 170. In some embodiments, the control panel 325 includes a controller configured to control operation of the mobile generator system based on monitored characteristics associated with one or more of the engine 160, the gearbox 155, or the generator 170 (e.g., temperature, pressure, voltage, and frequency). In some embodiments, the control panel 325 includes a high-current circuit breaker (e.g., a 4000 amp, 3-pole breaker) providing time overcurrent and instantaneous trip protection, and may include full-rated bus bars and a ground connection for field deployment. The control panel 325 may further provide an operator interface (e.g., a human-machine interface) and communication interfaces (e.g., a J1939 interface and a networked data link) to support monitoring, load-application rate control, and operating modes including stand-alone operation and utility synchronization.

The frame 300 provides structural support for the engine 160, gearbox 155, generator 170, cooling components 305, exhaust component 310, and control panel 325 and may be configured as a skid (e.g., defined within a frame) integrated with, or mounted to, the trailer 320. In some embodiments, the frame 300 may also support auxiliary equipment such as a jacket water heater, an on-board battery charger, a generator anti-condensation heater, a fire suppression system, one or more emergency-stop actuators, and/or the like. The frame apertures 315 may be configured to receive lifting implements and/or securement hardware, such as forklift tines, shackles, or tie-down straps, to facilitate transport and positioning of the mobile generator system. The trailer 320 may include one or more axles and road wheels and may be configured to be towed to an operating location, where the mobile generator system is deployed for continuous duty electrical power generation.

Referring now to FIG. 4, a perspective view of a mobile power generation unit 175 mounted on a trailer 320 is shown. In the illustrated configuration, the power generation unit 175 includes an internal combustion engine 160 mechanically coupled to a generator 170 through a gearbox 155, and further includes an exhaust component 310 associated with the engine 160. FIG. 4 illustrates an example transportable arrangement in which the major rotating equipment is aligned along a longitudinal axis of the trailer 320 to provide a compact, towable package for field deployment.

The internal combustion engine 160 provides motive power to the generator 170 via the gearbox 155. In some embodiments, the gearbox 155 is configured as a reduction gearbox that receives an input speed from the engine 160 and outputs a reduced speed to the generator 170 while multiplying torque, thereby enabling the engine 160 to operate at an engine speed suitable for torque production while the generator 170 operates at a lower generator speed suitable for producing alternating-current electrical output. The gearbox 155 may include one or more coupling interfaces (e.g., flexible couplings and/or flanged connections) to accommodate alignment tolerances and to reduce transmission of vibration between the engine 160 and the generator 170.

The generator 170 is supported on the trailer 320 and is operably coupled to receive mechanical power from the gearbox 155. In some embodiments, the generator 170 comprises a three-phase alternator configured to provide a nominal alternating-current output (e.g., 480 Vac at 60 Hz) to one or more external electrical loads (not shown), and may include associated excitation and voltage regulation hardware. Although not shown in detail in FIG. 4, the generator 170 may include an electrical connection region (e.g., a terminal box and/or conduit entry) coupled to downstream distribution and protection equipment mounted on the trailer 320 or within an associated enclosure (e.g., housing 800 shown in FIG. 8).

The exhaust component 310 is coupled to the internal combustion engine 160 to convey combustion exhaust away from the engine 160. In some embodiments, the exhaust component 310 includes one or more of an exhaust manifold connection, an exhaust conduit, and a muffler volume, and may terminate at an outlet arranged to discharge exhaust at a selected location relative to the trailer 320 (e.g., above the trailer deck and/or laterally outward of the trailer footprint). In further embodiments, the exhaust component 310 may include one or more emissions-control elements (e.g., a catalyst) selected to meet a desired emissions target.

FIG. 4 further depicts a cooling assembly positioned adjacent an end region of the trailer 320 and proximate the internal combustion engine 160. The cooling assembly may include one or more forced-air devices (e.g., an array of fans) driving airflow through one or more heat exchangers to reject heat from one or more thermal circuits associated with the engine 160 and/or other components of the power generation unit 175.

The trailer 320 supports the power generation unit 175 as an integrated mobile platform and may include one or more axles and road wheels to facilitate transport to an operating location. In some embodiments, the engine 160, gearbox 155, and generator 170 are mounted to the trailer 320 to provide a desired weight distribution for towing and to maintain service access to the exhaust component 310 and other serviceable elements. The trailer 320 may further include tie-down points, leveling features, and/or stabilizers configured to support stationary operation of the power generation unit 175 at a deployment site.

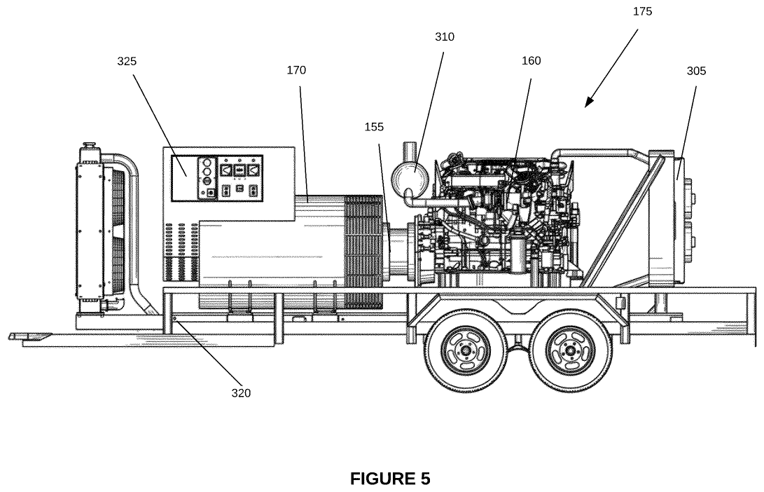

Referring now to FIG. 5, a side elevational view of a mobile natural-gas-powered generator system is shown as a power generation unit 175 mounted on a trailer 320. The power generation unit 175 includes an internal combustion engine 160, a gearbox 155 operably coupled to the internal combustion engine 160, and a generator 170 coupled to the gearbox 155. FIG. 5 further depicts cooling components 305 associated with the engine 160, an exhaust component 310 coupled to the engine 160, and a control panel 325 positioned adjacent the generator 170. The relative placement of these components on the trailer 320 provides a compact, transportable arrangement configured for field deployment and continuous-duty electrical power generation.

With continued reference to FIG. 5, the internal combustion engine 160 provides mechanical output to drive the generator 170 through the gearbox 155. In some embodiments, the gearbox 155 comprises a reduction gearbox configured to receive an input speed from the engine 160 and to output a reduced speed to the generator 170 while multiplying torque, thereby enabling the engine 160 to operate within a selected engine-speed range while the generator 170 operates at a lower speed suitable for the desired electrical output. For example, the gearbox 155 may be implemented as a compound gear train having a parallel-axis, twin countershaft configuration providing a reduction ratio on the order of about 2.5:1 (e.g., about 2200 RPM input to about 900 RPM output) with drivetrain efficiency on the order of about 95%. The generator 170 may be configured to provide three-phase alternating current (e.g., nominal 480 Vac at 60 Hz) at the generator operating speed by selection of a pole count and regulation strategy.

Cooling components 305 are shown mounted above and/or adjacent to the internal combustion engine 160. In some embodiments, the cooling components 305 include one or more heat exchangers (e.g., a radiator) and one or more forced-air devices (e.g., fans) configured to reject heat from an engine jacket-water circuit and, optionally, from additional thermal circuits such as charge-air cooling, lube-oil cooling, and/or cooling for the gearbox 155 and/or generator 170. The elevated placement of the cooling components 305 relative to the engine 160, as depicted in FIG. 5, may support a compact trailer footprint while promoting airflow through the heat exchangers and maintaining service access to the engine 160 from a lateral side of the trailer 320.

The exhaust component 310 is coupled to the internal combustion engine 160 and is arranged to convey exhaust gases away from the engine 160 to a selected discharge location. In some embodiments, the exhaust component 310 includes one or more conduits and an acoustic attenuation volume (e.g., a muffler). In further embodiments, the exhaust component 310 may include an emissions-control element (e.g., a catalyst) selected to meet an emissions target for the engine 160. The routing of the exhaust component 310 along a lateral side of the power generation unit 175 may facilitate thermal isolation from the control panel 325 and may support installation of an optional enclosure (e.g., housing 800 shown in FIG. 8) over the trailer 320.

The generator 170 is mounted on the trailer 320 and mechanically driven by the internal combustion engine 160 via the gearbox 155. In some embodiments, the control panel 325 is mounted to, or adjacent to, the generator 170 and houses electrical distribution, protection, and control components for the power generation unit 175. For example, the control panel 325 may include a high-current circuit breaker (e.g., a 4000 amp, 3-pole breaker) providing time overcurrent and instantaneous trip protection, and may further include full-rated bus bars and a ground connection for field deployment. Additionally, the control panel 325 may include integrated engine and generator controls and communication interfaces, such as a local human-machine interface, a communication interface, and/or a networked data link, to support monitoring of operating parameters and control functions including rate-of-load application control and synchronization in operating modes that include stand-alone operation and utility synchronization.

The trailer 320 supports the power generation unit 175 as an integrated, towable package and, as shown in FIG. 5, may include a multi-axle running gear configured to support the combined mass of the generator 170, the gearbox 155, the internal combustion engine 160, the cooling components 305, and the control panel 325. In some embodiments, the placement of the generator 170 and engine 160 at a relatively low elevation on the trailer 320 may reduce a center of gravity of the package, while the longitudinal arrangement of the drivetrain components may facilitate weight distribution proximate the trailer axles for towing. The length and weight of the power generation unit 175 may vary, but generally the gearbox allows for a reduced motor size that decreases the total length and/or weight of the power generation unit 175. For example, the power generation unit may be approximately 125-250 inches long (e.g., 203 inches in an example embodiment) and less than 25,000 lbs (e.g., enabling movement by more vehicle types).

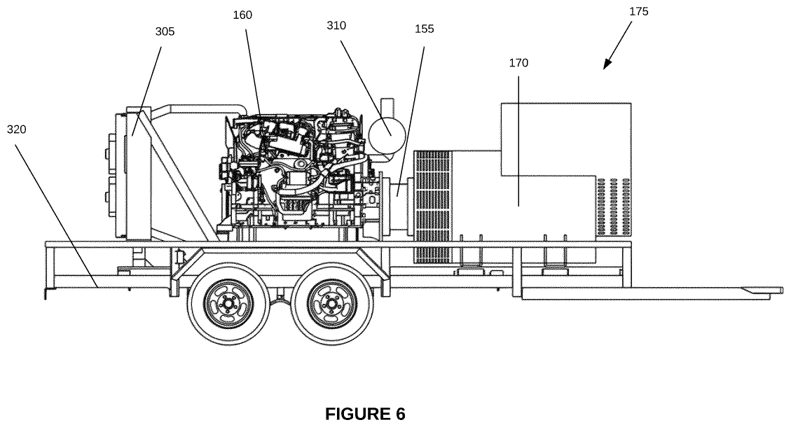

Referring now to FIG. 6, a side elevational view of a mobile natural-gas-powered generator system is shown as a power generation unit 175 mounted on a trailer 320. The power generation unit 175 includes an internal combustion engine 160, a gearbox 155 operably coupled to the internal combustion engine 160, and a generator 170 connected to the gearbox 155. FIG. 6 further depicts cooling components 305 and an exhaust component 310 arranged on the trailer 320 to support mobile, field-deployable operation.

With continued reference to FIG. 6, the internal combustion engine 160 provides a prime mover for the generator 170 and may be implemented as a spark-ignited natural-gas/methane engine configured to receive a gaseous fuel supply. For example, the fuel supply may be provided at about 60 psi to about 150 psi with a methane content of at least about 65%. The internal combustion engine 160 may be mounted on the trailer 320 via vibration-isolation mounts and may operate in an engine-speed range selected for torque production (e.g., about 1800 RPM to about 2200 RPM), while the gearbox 155 enables the generator 170 to operate at a different rotational speed than the internal combustion engine 160.

The gearbox 155 mechanically couples an output of the internal combustion engine 160 to an input of the generator 170. In some embodiments, the gearbox 155 comprises a compound reduction gearbox having a parallel-axis, twin countershaft configuration that reduces rotational speed and multiplies torque, such as by a reduction ratio of about 2.5:1 and an efficiency on the order of about 95%. By way of example, the gearbox 155 may convert an engine output of about 2200 RPM to a generator input of about 900 RPM while increasing torque delivered to the generator 170.

With continued reference to FIG. 6, the internal combustion engine 160 provides mechanical power to the gearbox 155. In some embodiments, the internal combustion engine 160 comprises a spark-ignited natural-gas/methane engine (e.g., a 15 liter, six-cylinder engine) configured to receive a gaseous fuel supply within a pressure range of about 60 psi to about 150 psi and having a methane content of at least about 65%, although other fuel supply conditions may be used. The gearbox 155 may be configured as a speed-reduction gearbox that reduces rotational speed from the internal combustion engine 160 to the generator 170 while multiplying torque, thereby enabling use of an internal combustion engine that is smaller than an engine selected for a direct-coupled generator set having a same electrical output rating. In some embodiments, the gearbox 155 comprises a compound reduction gearbox having a parallel-axis, dual/twin countershaft architecture and a reduction ratio of about 2.5:1 (e.g., about 2200 RPM input to about 900 RPM output) with an efficiency of about 95%, although other reduction ratios (e.g., about 2:1 to about 3:1) may be used; additionally or alternatively, the gearbox 155 may employ other reduction architectures (e.g., a planetary gear train) configured to provide a desired reduction ratio.

In the illustrated arrangement, the generator 170 is mounted adjacent the gearbox 155 and receives mechanical power from the gearbox 155 to produce electrical output. In some embodiments, the generator 170 is a three-phase alternator configured to provide nominal 480 Vac output at 60 Hz and may include brushless excitation and a voltage regulator to control output voltage under varying load. The generator 170 may be selected to provide high power density (e.g., via rare earth materials and/or other advanced materials and construction techniques) such that rated power output is achievable at relatively low generator rotational speeds, such as about 900 RPM and/or about 1200 RPM, to support a compact package on the trailer 320.

For alternating-current generation, an output frequency of a generator (e.g., generator 170) may be established based on a relationship between a rotor speed of the generator and an electromagnetic pole count of the generator, and/or by electrical frequency conditioning of electrical output produced by the generator. In some embodiments, the generator is configured to provide an alternating-current output at about 60 Hz when operated at a certain generator speed (e.g., generator speeds from approximately 900 rpm to approximately 1200 rpm), and the generator pole configuration and/or frequency conditioning approach is selected accordingly.

In implementations in which the generator directly produces a substantially fixed-frequency alternating-current output (e.g., a synchronous alternator operated at a controlled speed), an electrical frequency f (Hz) may be expressed as f=(P*N)/120, where P is a number of poles of the generator and N is a rotor speed in revolutions per minute (rpm). Accordingly, for an output frequency of about 60 Hz, a 6-pole configuration may be operated at about 1200 rpm, and an 8-pole configuration may be operated at about 900 rpm. As such, the output speed converted by the gearbox 155 may be in line with the output speeds necessary for the selected frequency.

In some implementations, the generator is provided in alternative pole-count configurations and the power generation unit is configured for a selected generator operating speed (e.g., about 900 rpm-1200 rpm) by selecting a generator pole-count configuration and selecting a corresponding reduction ratio of a reduction gearbox (e.g., gearbox 155) that couples an internal combustion engine (e.g., engine 160) to the generator. In some implementations, the generator includes a stator winding arrangement that is configurable (e.g., during manufacture and/or commissioning) to provide a selected pole configuration so that the generator produces about 60 Hz at the selected generator speed.

In other implementations, a power-electronic frequency conversion stage may be used to decouple generator mechanical speed from an output frequency delivered to one or more electrical loads. For example, electrical output produced by the generator may be coupled to power-electronic circuitry configured to provide an output at a selected frequency, such as about 60 Hz, while permitting the generator to operate at a selected mechanical speed, such as about 900 rpm and/or about 1200 rpm. In such implementations, integrated controls may regulate the internal combustion engine and/or the power-electronic frequency conversion stage to provide a desired output frequency for stand-alone operation and/or for synchronization in a utility-parallel operating mode.

Electrical output from the generator 170 may be routed to output protection and distribution equipment, such as a multi-pole circuit breaker, bus bars, and a ground connection, to facilitate connection to one or more external loads and/or utility interconnection equipment.

As further shown in FIG. 6, the cooling components 305 are disposed adjacent the internal combustion engine 160 and may include one or more heat exchangers and one or more forced-air devices configured to reject heat from one or more thermal circuits of the power generation unit 175. For example, the cooling components 305 may include a radiator and fan arrangement configured to cool an engine jacket-water circuit and, in some embodiments, may additionally cool charge air, lube oil, and/or lubricant associated with the gearbox 155. The cooling components 305 may be positioned at an end region of the trailer 320 to promote airflow through the heat exchangers during operation and to provide service access to the internal combustion engine 160 and associated plumbing.

The exhaust component 310 is coupled to the internal combustion engine 160 and is configured to convey combustion exhaust away from the internal combustion engine 160 to a selected discharge location relative to the trailer 320. In some embodiments, the exhaust component 310 includes an exhaust conduit and a muffler volume, and may be routed to reduce heat exposure to the generator 170 and adjacent structural members. In further embodiments, the exhaust component 310 may include an aftertreatment assembly, such as an oxidation catalyst and/or a three-way catalyst, to support compliance with emissions targets.

The trailer 320 supports the power generation unit 175 as an integrated mobile platform and may include one or more axles, wheels, and a tow interface to facilitate transport to and from an operating location. In some embodiments, mounting of the internal combustion engine 160, gearbox 155, generator 170, cooling components 305, and exhaust component 310 on the trailer 320 is selected to provide a desired weight distribution and a relatively low center of gravity to improve towing stability. The compact longitudinal arrangement depicted in FIG. 6 may contribute to reduced packaged length and reduced packaged weight relative to direct-coupled generator sets, thereby enabling transport by light-duty towing vehicles in at least some implementations. The trailer 320 may further include leveling and stabilization features to support stationary operation at a deployment site. For example, stabilizing jacks may be used to allow usage of the power generation unit 175 while positioned on the trailer 320. Additionally or alternatively, the power generation unit 175 may be removed from the trailer 320 before use (e.g., placed on a ground surface or otherwise secured).

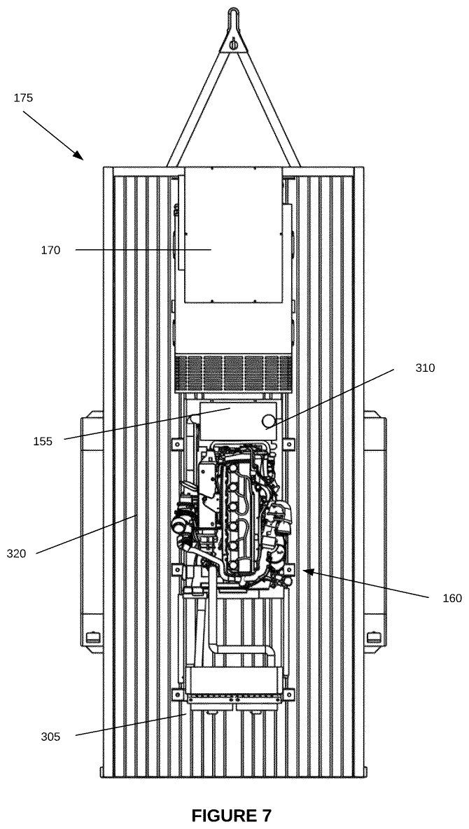

Referring now to FIG. 7, a top plan view of a mobile natural-gas-powered generator system is shown as a power generation unit 175 mounted on a trailer 320. In the illustrated example, a generator 170, a gearbox 155, and an internal combustion engine 160 are disposed in a generally longitudinal arrangement on the trailer 320, while cooling components 305 and an exhaust component 310 are positioned to support continuous-duty operation in field environments. The top plan perspective of FIG. 7 further illustrates that the power generation unit 175 may be implemented as an integrated, towable package in which major rotating equipment is contained within a lateral footprint of the trailer 320 for transport and deployment.

With continued reference to FIG. 7, the internal combustion engine 160 provides mechanical power to the generator 170 through the gearbox 155. In some embodiments, the gearbox 155 comprises a speed-reduction gearbox that reduces rotational speed from an engine output shaft to a generator input shaft while multiplying torque, thereby enabling the internal combustion engine 160 to operate in an engine-speed range suited to torque production while the generator 170 operates at a lower speed suited to alternating-current generation. For example, and as described above with respect to FIG. 6, the gearbox 155 may comprise a compound reduction gearbox having a parallel-axis, dual/twin countershaft architecture and a reduction ratio of about 2.5:1 (e.g., about 2200 RPM input to about 900 RPM output) with an efficiency of about 95%, although other reduction ratios (e.g., about 2:1 to about 3:1) may be used. Additionally or alternatively, the gearbox 155 may employ another reduction architecture (e.g., a planetary gear train) configured to provide a desired reduction ratio. The longitudinal alignment of the engine 160, the gearbox 155, and the generator 170 may facilitate coupling via flanged interfaces and/or flexible couplings and may reduce overall packaged length relative to a direct-coupled generator set configured for a comparable electrical output.

In the illustrated arrangement, the generator 170 is positioned toward an end region of the trailer 320 and is configured to convert mechanical power received from the gearbox 155 into electrical output for one or more external loads. In some embodiments, the generator 170 comprises a three-phase alternator configured for nominal 480 Vac output at 60 Hz and includes brushless excitation and a voltage regulator to control output voltage under varying load. The generator 170 may be selected to provide comparatively high power density such that rated power output is achievable at relatively low generator rotational speeds, such as about 900 RPM and/or about 1200 RPM, to support a compact packaging arrangement on the trailer 320. In some embodiments, electrical output protection and distribution equipment (e.g., a multi-pole circuit breaker, bus bars, and a ground connection), and integrated engine/generator controls (e.g., a controller providing load-application rate control and synchronization, a local HMI, a communication interface, a networked data link, etc.) may be mounted on and/or adjacent the generator 170, for example in an enclosure (e.g., housing 800 shown in FIG. 8) located above the generator 170 as depicted in FIG. 8.

As further shown in FIG. 7, the cooling components 305 are positioned toward an opposite end region of the trailer 320 relative to the generator 170, which may support thermal separation between high-heat-rejection components and electrical output components. In some embodiments, the cooling components 305 include one or more heat exchangers and one or more forced-air devices configured to reject heat from an engine jacket-water circuit and, optionally, from additional thermal circuits such as charge-air cooling, lube-oil cooling, and/or lubricant cooling associated with the gearbox 155. The top plan view illustrates that the cooling components 305 may be mounted transversely across the trailer 320 to draw airflow from lateral sides of the trailer 320 and discharge heated airflow away from the power generation unit 175, thereby supporting operation in higher ambient temperature conditions.

The trailer 320 supports the power generation unit 175 as an integrated mobile platform and may include a tow interface, one or more axles, and road wheels (not shown in the top plan view) to facilitate transport to and from an operating location. As depicted in FIG. 7, open deck regions may be present along one or both lateral sides of the engine 160 and generator 170, which may provide access pathways for inspection, refueling, and/or fuel line connections, and maintenance activities while the power generation unit 175 remains mounted on the trailer 320. In some embodiments, the placement of the generator 170 proximate the tow end of the trailer 320 may facilitate routing of power cables to external loads and/or to utility interconnection equipment, while the placement of the cooling components 305 toward an opposite end may support heat rejection away from operator access points. The trailer 320 may further include leveling and stabilization features and/or may be implemented as, or within, an enclosed trailer configuration for additional environmental protection.

Referring now to FIG. 8, a perspective view of a mobile generator system is shown in which a power generation unit 175 is implemented as an enclosed, trailer-mountable package. In the illustrated embodiment, the power generation unit 175 is carried by a trailer 320 and enclosed within a power generation unit housing 800 such that major powertrain components and associated auxiliaries are protected during transport and field operation. The enclosed configuration of FIG. 8 may be used, for example, to provide additional environmental protection relative to the open-deck arrangements described above with respect to FIGS. 6 and 7.

With continued reference to FIG. 8, the housing 800 may comprise a trailer body defining side walls, a roof, and end walls that at least partially surround the power generation unit 175. In some embodiments, the housing 800 is configured to inhibit ingress of precipitation, dust, and debris while permitting access for inspection and service, for example, via one or more doors, removable panels, and/or service openings (one example service opening is shown in an open condition in FIG. 8). Additionally, the housing 800 may provide one or more of acoustic attenuation, physical security, and shielding of hot and/or rotating components from inadvertent contact.

The housing 800 further defines ventilation features that support heat rejection and air exchange during operation of the power generation unit 175. For example, a roof vent opening 805 is disposed in an upper region of the housing 800, and a rear vent opening 810 is disposed in a rear wall region of the housing 800. In some embodiments, the rear vent opening 810 provides an airflow path for at least one cooling air stream (e.g., to support operation of one or more heat exchangers and/or fans within the housing 800), and the roof vent opening 805 provides an exhaust path for heated air. Additionally or alternatively, the roof vent opening 805 and/or the rear vent opening 810 may include louvers, baffles, screens, and/or filters configured to manage water intrusion, particulate ingress, and/or noise emission while maintaining a desired ventilation flow rate.

In the illustrated embodiment, a control panel 325 is mounted to the trailer 320 and/or to the housing 800 in a position that may be accessible from an exterior of the enclosed package. The control panel 325 may house at least a portion of the electrical distribution, protection, and control electronics for the power generation unit 175, thereby supporting operation while the housing 800 remains closed. In some embodiments, the control panel 325 includes a controller configured to coordinate operation of an internal combustion engine, a reduction gearbox, and a generator of the power generation unit 175 (e.g., controlling a rate of load application and supporting operating modes including stand-alone operation and utility synchronization), and may further include a local human-machine interface and one or more communication interfaces (e.g., a communication interface and a networked data link) for monitoring and remote operation. In some embodiments, the control panel 325 further includes electrical output protection and connection hardware such as a multi-pole circuit breaker, bus bars, and a ground connection.

The trailer 320 supports the housing 800 and the enclosed power generation unit 175 as a mobile platform configured for transport to and deployment at an operating location. In some embodiments, the trailer 320 includes a tow interface, one or more axles, and road wheels such that the enclosed package is towable as a unit, and may further include leveling and/or stabilization features to support stationary operation. The enclosed configuration of FIG. 8 may be used with different fuel implementations (e.g., a natural gas/methane configuration and/or a diesel configuration) while maintaining the integrated packaging approach in which ventilation openings (e.g., roof vent opening 805 and/or rear vent opening 810) support thermal management and the control panel 325 supports protected access to monitoring and control functions.

Referring now to FIG. 9, a side elevation view of an enclosed, trailer-mountable generator system is shown in which a power generation unit 175 is carried by a trailer 320 and disposed within a power generation unit housing 800. In the illustrated example, the housing 800 provides an outer enclosure around at least a portion of the power generation unit 175 (e.g., an internal combustion engine, a reduction gearbox, and a generator as described herein), while a control panel 325 is positioned to be accessible from an exterior side of the housing 800 to support monitoring, control, and electrical connection functions during deployment.

With continued reference to FIG. 9, the housing 800 may be mounted on a trailer 320 and may define an overall package envelope suitable for road transport and field operation. The illustrated drawing includes example dimensional callouts indicating an example housing length of about 192.53 inches (without trailer) and an example housing height of about 66.74 inches (without trailer), and an example overall length of about 242.44 inches for the trailer-mounted package; however, the dimensions may vary based on the selected prime mover, cooling hardware, electrical distribution hardware, and/or regulatory constraints. The enclosed profile may inhibit direct exposure of the power generation unit 175 to precipitation, dust, and debris during transport and operation, while maintaining a compact arrangement relative to larger direct-coupled generator set packaging.

As further depicted in FIG. 9, the housing 800 includes a side access opening through which portions of the power generation unit 175 may be accessed for inspection and service. In some embodiments, the access opening is defined by a hinged door, a removable panel, and/or a roll-up door arrangement, and may be located to provide service access to at least one of an engine service side, a gearbox coupling region, a generator connection region, and/or an auxiliary equipment region. Additionally, the housing 800 may include ventilation features (e.g., louvers, ducted openings, and/or screened apertures) to support airflow for combustion air supply and heat rejection while the housing 800 remains closed during operation.

The control panel 325 is carried on a lateral side of the trailer 320 and, in some embodiments, is externally accessible without opening the housing 800. The control panel 325 may house electrical protection and distribution components for routing three-phase output from the power generation unit 175, such as a multi-pole circuit breaker, bus bars, and a ground connection, and may further include integrated engine and generator controls including a local human-machine interface, a communication communication interface, and a networked data link for remote monitoring and operation. In some embodiments, the control panel 325 supports operating modes including stand-alone operation and utility synchronization by controlling a rate of load application and implementing synchronization logic based on monitored operating parameters. In various embodiments, the control panel 325 may include various components discussed herein, such as a 4000 amp 3-pole breaker, external power connection points, local HMI, and/or the like.

Trailer 320 supports the housing 800 and the enclosed power generation unit 175 on a mobile platform including a tow interface and a multi-axle running gear, as shown in the side elevation profile. In some embodiments, the trailer 320 includes leveling and stabilization features (e.g., stabilizer jacks and/or outriggers) to support stationary operation at a deployment site, and may include routing provisions for fuel supply lines and power cables between exterior connection points and the enclosed power generation unit 175. Moreover, the enclosed trailer configuration of FIG. 9 may be used in a natural-gas/methane implementation in which a gaseous fuel supply is provided to the power generation unit 175 under disclosed supply conditions (e.g., supply pressure of about 60 psi to about 150 psi and methane content of at least about 65%), while providing a self-contained package for transport and rapid deployment.

Referring now to FIG. 10, a perspective view of an electrical machine configured as a generator is shown. The generator includes a generally cylindrical generator housing and an electrical terminal box mounted on an exterior surface of the generator housing. In some embodiments, the generator of FIG. 10 corresponds to generator 170 described above with respect to the mobile power generation unit, and the generator is configured to receive mechanical input power from a reduction gearbox 155 through a drive-end coupling interface.

With continued reference to FIG. 10, the electrical terminal box may define an enclosed volume that supports electrical terminations for the generator stator windings and associated sensing conductors. For example, the terminal box may include one or more removable cover panels to provide service access to electrical lugs, bus structures, and/or terminal blocks, and may include one or more cable entry features such as conduit hubs, cable glands, strain relief features, and/or connector interfaces. In some embodiments, the terminal box supports routing of three-phase output conductors and an equipment grounding conductor from the generator to downstream electrical distribution and protection hardware, such as a circuit breaker and bus bars provided in a control panel. Additionally, the terminal box may support routing of auxiliary conductors for voltage sensing, current sensing, and/or temperature sensing to facilitate regulation and monitoring of generator operating parameters. Any number of components may be disposed within the terminal box.

The generator housing shown in FIG. 10 may include an end flange and/or face mount structure at a drive end to facilitate coupling to the gearbox 155, for example through a flexible coupling, a splined coupling, and/or a flanged coupling interface. In some embodiments, the generator comprises a synchronous alternator having brushless excitation, including an exciter arrangement and rotating rectifier components disposed within the generator housing, with excitation-related conductors routed to the terminal box for connection and regulation. The generator may be configured to provide a nominal output voltage and frequency (e.g., about 480 VAC at about 60 Hz) at a generator speed that is lower than an engine speed, such as about 900 RPM and/or about 1200 RPM, by selection of a pole count and/or by use of power-electronic frequency conversion. For example, in a synchronous implementation, an 8 pole configuration may support approximately 60 Hz output at approximately 900 RPM and a 6 pole configuration may support approximately 60 Hz output at approximately 1200 RPM.

In some embodiments, the generator includes one or more mounting feet and/or base structures coupled to the generator housing to support mounting to a skid, frame, or trailer deck as described above for the mobile implementation. Furthermore, the generator housing may include ventilation openings and/or internal fan features configured to circulate cooling air through the generator, and the terminal box may be positioned to promote protected cable routing while maintaining service access. In some embodiments, the generator includes one or more auxiliary features such as an anti-condensation heater, one or more winding temperature sensors, and/or one or more bearing temperature sensors, with corresponding conductors routed to the terminal box for connection to integrated controls. The generator may be selected with insulation and environmental ratings suitable for outdoor service, such as insulation class H and a protection class such as IP23, and may be configured to meet a desired power quality target (e.g., total harmonic distortion less than a specified threshold at full load) under regulation control.

Referring now to FIG. 11, a perspective view of an example gear train formed by compound gearbox gears 1100 is shown. In some embodiments, the compound gearbox gears 1100 are disposed within a compound reduction gearbox (e.g., gearbox 155 described above) configured to mechanically couple the internal combustion engine 160 to the generator 170 and to convert a higher-speed, lower-torque input into a lower-speed, higher-torque output suitable for driving the generator 170. The gears 1100 of FIG. 11 are merely an example of gears used in a gearbox. Various embodiments discussed herein may use any number of different gearing styles (e.g., planetary gears, twin countershaft gear architecture shown in FIG. 11, etc.) that employ the reduction ratios discussed herein.

With continued reference to FIG. 11, the compound gearbox gears 1100 may be arranged on a plurality of parallel shafts, including an input shaft, an output shaft, and two countershafts, thereby forming a parallel-axis, twin countershaft architecture. In some embodiments, an input pinion on the input shaft meshes with respective first-stage gears on the two countershafts to split an input torque into first and second torque paths, and each countershaft carries a second-stage pinion that meshes with an output gear on the output shaft to recombine the torque paths at the output shaft. The gears 1100 may be keyed, splined, press-fit, and/or otherwise secured to the respective shafts to rotate with the shafts, and the countershafts may be positioned laterally about the input shaft and/or the output shaft to promote generally symmetric load sharing.

As shown in FIG. 11, a plurality of parallel shafts may be used to convert the power via the gearbox. The input shaft 1105 may be operably connected to the internal combustion engine 160 to be turned by the output of the internal combustion engine. The input shaft has one or more input shaft gears 1110. The input shaft gear(s) 1110 may be operably connected to a countershaft structure. As shown, the countershaft structure may include a first countershaft 1115 that includes first countershaft gear(s) 1120 connected to the first countershaft 1115 that are engaged with the input shaft gear(s) 1110 and a second countershaft gear(s) 1130 that are attached to a second countershaft 1125. An output shaft 1135 may share an axis with the second countershaft 1125 (e.g., the second countershaft 1125 and the output shaft 1135 may be the same shaft, with the second countershaft gear(s) 1130 providing the functionality of the second countershaft 1125) that receives combined torque from both countershafts at reduced rotational speed to drive the generator 170.

This twin countershaft architecture splits the input torque into dual transmission paths via the countershafts and recombines them at the output shaft, enabling a high reduction ratio (e.g., approximately 2.5:1) with drivetrain efficiency on the order of 95%, while distributing load to maintain compact gear and bearing dimensions. The efficiency may be determined based on various factors, such as composition of the gears. The efficiency may be used to determine the reduction ratio (e.g., a higher reduction ratio may be used to overcome a higher efficiency).

In operation, the compound gearbox gears 1100 cooperate to provide a speed reduction and corresponding torque multiplication between the input shaft and the output shaft. In various embodiments, the reduction ratio may be any of the reduction ratios discussed herein. For example, the reduction ratio may be approximately 1.1:1 to 5:1. For example, the compound reduction gearbox may provide a reduction ratio of approximately 2.5:1, such that an engine output (e.g., about 2200 RPM) may be converted to a generator input speed (e.g., about 900 RPM), with a corresponding increase in torque (e.g., about 2500 lb-ft input torque to about 6111 lb-ft output torque) at an efficiency on the order of about 95%. In some embodiments, splitting the transmitted power across the two countershafts reduces tooth loading and bearing loading for a given transmitted power level, which may support compact packaging of the gearbox within a mobile generator set.

The compound gearbox gears 1100 may be sized and spaced to support a desired torque capacity within a compact envelope. For example, the gear train may include primary gears having an outside diameter on the order of about 9 inches and a face width on the order of about 2.5 inches, with a centerline spacing between adjacent gear meshes on the order of about 7 inches. Additionally, the compound reduction gearbox housing (not shown) containing the gears 1100 may be configured with an overall size on the order of about 32 inches in width, about 19 inches in height, and about 28 inches in length, although other sizes may be used based on a selected gear ratio and torque rating. The gears 1100 may comprise spur gears, helical gears, and/or other toothed gears selected to provide a desired balance of efficiency, noise, and axial thrust.

Furthermore, although FIG. 11 depicts the compound gearbox gears 1100 in isolation, in some embodiments the gears 1100 are enclosed within a gearbox housing that supports shaft bearings, seals, and lubrication features for continuous duty operation. For example, the housing may define an oil sump for splash lubrication and/or may support pressure lubrication via an internal pump, with lubricant delivery directed to gear meshes and bearing locations to manage temperature and wear. The gearbox may further include one or more interfaces to monitoring and controls, such as speed sensing on the input shaft and/or output shaft and temperature sensing at a bearing location, to support integrated engine and generator control as described above.

Referring now to FIG. 12, an example internal combustion engine 160 is shown for use in the power generation unit 175 described herein. In some embodiments, the internal combustion engine 160 provides a mechanical output coupled to the gearbox 155, and the gearbox 155 provides a mechanical input to the generator 170. The internal combustion engine 160 may be implemented as a multi-cylinder engine, such as an inline six-cylinder engine, and may be configured for operation on a gaseous fuel, a liquid fuel, or a combination thereof. In a gaseous-fuel configuration, the internal combustion engine 160 may be configured to operate on natural gas, methane, or flare gas supplied within a pressure range of about 60 psi to about 150 psi and having methane content at or above about 65%, with a reduction in power output used for lower methane content.

With continued reference to FIG. 12, the internal combustion engine 160 may include an air handling component 1200 coupled to an intake path of the internal combustion engine 160. In some embodiments, the internal combustion engine 160 may include a turbocharger configured to provide compressed intake air to cylinder heads 1230. The cylinder heads 1230 may include combustion chambers and valve assemblies, and in a spark-ignited configuration may support coil on plug ignition 1205 to provide ignition energy for combustion in the cylinders. In a compression-ignited configuration, ignition may be initiated by compression within the cylinders and the coil on plug ignition 1205 may be omitted.

In some embodiments, the internal combustion engine 160 includes an exhaust gas recirculation (EGR) valve 1210 coupled between an exhaust path and an intake path to meter exhaust gas recirculation as a function of engine operating state. The fuel module 1215 may receive fuel from a fuel supply line and may condition and meter the fuel for delivery to the cylinders, including control of at least one valve, regulator, injector, or metering device. For gaseous-fuel operation, the fuel module 1215 may support adjustment of at least one of a fueling rate, an ignition timing, or an air-fuel ratio based on measured fuel characteristics, including methane content. For liquid-fuel operation, the fuel module 1215 may be configured to deliver diesel fuel to the cylinders based on commanded torque and speed.

In some embodiments, the internal combustion engine 160 includes an ignition control module 1220 and an engine control module 1225 that implement control of combustion and emissions-related subsystems. The engine control module 1225 may receive sensor inputs representing engine operating parameters, including at least one of intake pressure, intake temperature, exhaust temperature, crankshaft speed, fuel supply pressure, or engine coolant temperature, and may output control signals to the fuel module 1215, the coil on plug ignition 1205, and the EGR valve 1210. In some embodiments, the engine control module 1225 is coupled to a communication interface that supports data exchange with a controller of the power generation unit 175 and/or with the computing device 152. The communication interface may include a controller area network interface that supports various message set(s), such as a J1939 message set. In some embodiments, the ignition control module 1220 and the engine control module 1225 support protective actions under fault conditions, including limiting commanded torque, limiting engine speed, or initiating a shutdown sequence.

Referring now to FIG. 13, an example user interface 1300 is shown (e.g., provided on a display device 280 shown in FIG. 2). The user interface 1300 includes various different characteristics monitored relating to the power generation unit 175. The user interface 1300 may provide information relating to the power generation unit 175. For example, the user interface 1300 may provide the characteristic(s) value(s) and/or error messages relating to one or more characteristics.

Example monitored characteristics, as shown in FIG. 13, include temperature values (e.g., motor temperature (tmot), oil temperature (toil), internal temperature (tint), ambient temperature (tamb), post filter air temperature (tPostFilterAire), input temperature (tCompIn), output temperature (tCompOut), exhaust temperature (tExhaust), and/or the like), generator output values (e.g., voltage (ub), frequency, excitation, and/or the like), pressure values (e.g., fuel pressure (pfuel), oil pressure (poil), pressure differences (pDPFdelta), crank pressure (pcrank), ambient pressure (pamb), post filter air pressure (pPostFilterAire), input pressure (pCompIn), output pressure (pCompOut), exhaust pressure (pExhaust), purge air pressure (pPurgeAir), and/or the like), System load, relative humidity values, specific humidity values, motor RPM values (nmot), performance values relating to various components (e.g., aps, ath), operating time values (e.g., lteng, ltstarter), and/or the like.

Any number of characteristics relating to the power generation unit 175 may be monitored and/or shown on the user interface 1300. In various embodiments, the values on the user interface 1300 may be customizable (e.g., a user may change the values to monitor and/or show). In various embodiments, one or more characteristics may be monitored, but not displayed via the user interface 1300. While the characteristics are shown on the user interface 1300, the information may be provided in various different forms (e.g., reports may be generated based on one or more characteristics relating to the power generation unit 175).

The monitored values may be compared to desired ranges and/or values of the characteristic(s). For example, the system may compare the monitored values to historical data (e.g., from the same power generation unit or similar), expected data (e.g., simulated data and/or target operating ranges), and/or the like. In various embodiments, an operating condition of the power generation unit 175 may be determined based on one or more of the monitored characteristic(s). For example, the operating condition of the power generation unit 175 may be normal or abnormal. Any number of different operating condition statuses may be contemplated.

In various embodiments, a user may adjust the power generation unit 175 via the computing device(s) 152. For example, the user may input adjustments to the power generation unit 175 via the user interface 1300 (e.g., using a user input device 281). In various embodiments, a user may be able to adjust desired values (e.g., parameters) for monitored characteristic(s). For example, the user may be able to change the target internal motor temperature.

In various embodiments, the system may automatically adjust one or more parameters based on the operation of the power generation unit 175. For example, the system may automatically adjust the parameter(s) based on the efficiency and/or power output of the system. The system may also adjust the specific components of the power generation unit 175 based on the monitored characteristic(s) (e.g., the engine speed may be adjusted based on the monitored characteristic(s)).

Referring now to FIG. 13, a control and monitoring interface for a mobile generator system is shown rendered on a display device 280. In the illustrated embodiment, the display device 280 presents a user interface 1300 that may be generated by a controller of the generator system and/or by a computing device in communication with the controller. The user interface 1300 may provide an operator with real-time operating information and, in some embodiments, may also accept operator inputs for controlling the generator system during commissioning, deployment, and continuous operation.

In some embodiments, the user interface 1300 includes a plurality of data regions arranged to present operating characteristics associated with a prime mover and supporting subsystems. For example, the user interface 1300 may display engine-related temperatures and pressures, such as an engine coolant and/or block temperature (e.g., “tmot”), a lubricant temperature (e.g., “toil”), an internal or enclosure temperature (e.g., “tint”), and an oil pressure (e.g., “poil”), each with an associated unit of measure. The user interface 1300 may further display an engine speed (e.g., “nmot”) and other control-related parameters (e.g., throttle and/or actuator positions), which may be used by the controller to regulate speed, torque, and load acceptance. In some embodiments, the displayed values are derived from one or more sensors coupled to the engine and/or from an engine control module, including values communicated over a vehicle network, such as a J1939-compatible link.

In some embodiments, the user interface 1300 further presents intake-air, exhaust, and fuel characteristics that are indicative of combustion conditions and available power. By way of example, the user interface 1300 may display a fuel supply pressure (e.g., “pfuel”) and a combustion metric (e.g., an air-fuel equivalence ratio or lambda value, such as “LAM”), and may display intake and ambient pressures including an ambient pressure (e.g., “pamb”), a pressure downstream of an intake filter (e.g., “pPostFilterAir”), and compressor inlet and outlet pressures and temperatures (e.g., “pCompIn”, “pCompOut”, “tCompIn”, “tCompOut”). The user interface 1300 may also display exhaust-side measurements, such as exhaust pressure (e.g., “pExhaust”) and exhaust temperature (e.g., “tExhaust”), and may optionally display parameters associated with an exhaust aftertreatment assembly (if present), such as a differential pressure and/or exit temperature (e.g., “pDPFdelta” and “tDPFExit”). Additionally, the user interface 1300 may present ambient condition values such as ambient temperature (e.g., “tamb”) and humidity-related values (e.g., relative humidity and/or specific humidity), which may be used to adjust fueling, ignition timing, load limits, and/or emissions control strategies.

In some embodiments, the user interface 1300 includes, or is associated with, one or more screens that present electrical output characteristics of an alternator and downstream output hardware. For example, the user interface 1300 may present one or more of generator terminal voltage, frequency, current, real power, apparent power, power factor, excitation parameters, and breaker status, and may present associated limit values and alarms. Such electrical quantities may be used to support closed-loop regulation of output voltage and frequency and to support protective actions by output protection hardware (e.g., tripping or inhibiting closure of an output breaker upon detection of an overcurrent or out-of-tolerance condition). The user interface 1300 may further provide status indicators and control inputs for operating modes including a stand-alone mode and a utility-synchronization mode, for example by presenting synchronization information such as phase angle, slip frequency, and permissive conditions for breaker closure.

Moreover, the user interface 1300 may support operator entry of commands and setpoints that are used by the controller to control the generator system based on monitored characteristics. In the illustrated example, a load-related setpoint (e.g., “LoadbankSet”) is displayed, and the controller may use such setpoints to control a rate of load application, a maximum load level, and/or a load ramp profile. In various embodiments, the user interface 1300 may include start and stop controls, purge and/or ignition enable controls, setpoints for desired engine speed, setpoints for desired electrical output (e.g., voltage and frequency), and configurable alarm thresholds. For example, when operating on variable-quality gaseous fuel, the user interface 1300 may display a fuel quality metric (e.g., methane content) and the controller may automatically derate or adjust operation based on the fuel quality metric to maintain stable combustion and electrical output.

In some embodiments, the user interface 1300 supports diagnostics and maintenance by presenting runtime information and event data. For example, the user interface 1300 may display cumulative operating hours (e.g., “lteng”), starter engagement time (e.g., “ltstarter”), and stored fault codes associated with monitoring of engine, generator, and/or drivetrain conditions, and may provide access to logged data for trending and post-event analysis. Additionally, the user interface 1300 may be rendered locally at the generator system and/or remotely via a networked data link, thereby supporting remote monitoring and remote operation using a wired or wireless network connection, including remote start/stop and parameter adjustment. In some embodiments, the user interface 1300 further presents status information for auxiliary equipment, such as one or more heaters, a battery charger, a fire suppression system, and/or emergency-stop circuits, and may display communications status for one or more device networks used by the generator system.

Referring now to FIG. 14, a flare gas burn off environment 1400 is shown, such as an example wellsite flare installation in which flare gas is combusted at one or more burner(s) 1405 located at upper ends of elevated flare stacks. In the illustrated example, multiple burner(s) 1405 produce visible flames, indicating active flaring of a gaseous hydrocarbon stream. The flare gas burn off environment 1400 may be representative of oil and gas operations in which gas is intermittently or continuously routed to a flare for disposal and site safety.

In some operating scenarios, flare gas is generated by separators, tanks, or other production equipment and is routed through a flare header and associated piping (not labeled) to the burner(s) 1405. The burner(s) 1405 may include a flare tip, ignition source, and/or pilot arrangement that initiates and maintains combustion of the flare gas as it exits the flare stack. Flaring at burner(s) 1405 may reduce accumulation of combustible gas at the site and may serve as a controlled pressure-relief pathway. However, the flared stream may contain recoverable chemical energy that may otherwise be converted to useful work, and the flared stream may exhibit variable composition, pressure, and flow rate.

In accordance with various embodiments described herein, at least a portion of the flare gas that would otherwise be combusted at burner(s) 1405 may be diverted upstream of the burner(s) 1405 and provided as a fuel source to a mobile power generation unit (e.g., power generation unit 175). For example, a tee connection or tapping manifold may be coupled to the flare header to route flare gas to the internal combustion engine fuel inlet while maintaining a bypass path to the burner(s) 1405 for continued flaring when desired or required. A shutoff valve and/or emergency shutdown valve may be provided in the diversion line to isolate the power generation unit from the flare header, and one or more check valves and/or flame arrestors may be provided to inhibit backflow and flame propagation toward the flare header. In some embodiments, the diverted flare gas is regulated to a selected supply pressure range, such as about 60 psi to about 150 psi, by one or more pressure regulators, control valves, and/or a booster compressor when the available flare header pressure is below a target inlet pressure. Additionally, a buffer volume or surge tank may be used to attenuate short-term flow transients associated with intermittent flaring and to provide a more stable fuel supply to the internal combustion engine.

Additionally, the diverted flare gas may be processed by a fuel pre-conditioning subsystem prior to delivery to the internal combustion engine. The fuel pre-conditioning subsystem may include, for example, a knock-out vessel or separator to remove entrained liquids, a coalescing filter to remove aerosols, and a particulate filter to reduce solids ingestion, thereby protecting downstream metering and combustion components. In some embodiments, the fuel pre-conditioning subsystem includes one or more treatment stages configured to reduce contaminant levels, such as removal of hydrogen sulfide (H2S) and/or other sulfur species, and removal of water vapor to limit corrosion and improve combustion stability. Fuel quality sensing may be performed using one or more sensors coupled to the fuel stream, such as a methane-content sensor, a gas heating-value estimator, or a gas composition analyzer, and the measured values may be communicated to a controller for use in determining an operating limit or derate schedule. In some embodiments, preliminary testing of the flare gas at the deployment location is used to calibrate one or more control parameters for operation on the local flare gas stream.

Moreover, a controller and/or computing device (e.g., computing device(s) 152) may control operation of the power generation unit in response to characteristics of the flare gas derived from the flare gas burn off environment 1400. For example, the controller may compare a measured methane content to a threshold (e.g., at least about 65% methane) and may responsively adjust one or more operating parameters, including fuel metering rate, air-fuel ratio, ignition timing, boost control, and/or commanded engine speed, to maintain stable combustion and emissions performance. The controller may also control electrical loading to manage transient response, including controlling a rate of load application, limiting a maximum real power output, and/or shedding load in response to detected fuel quality degradation, thereby reducing the likelihood of misfire, knock, or stall events when flare gas availability changes. In some embodiments, if one or more fuel characteristics fall outside an allowable range (e.g., methane content below a minimum, supply pressure below a minimum, or detected contaminant level above a limit), the controller initiates a protective action, such as derating, transitioning to an alternate fuel source, or shutting down the power generation unit, while allowing continued routing of flare gas to burner(s) 1405. Operating data associated with flare gas usage (e.g., methane content, fuel pressure, and fuel consumption) may be logged and transmitted over a networked data link for remote monitoring and for verification of flaring reduction.

Accordingly, FIG. 14 illustrates a representative flare gas burn off environment 1400 in which a usable fuel stream is conventionally combusted at burner(s) 1405, and in which various embodiments described herein may reduce flaring by converting at least a portion of the flare gas to electrical power. In deployment, the mobile power generation unit may be positioned at or near the flare gas burn off environment 1400 and connected to the flare header to consume flare gas that would otherwise be flared, while still maintaining the flare stack as a safety device for excess gas. In this manner, the flare gas burn off environment 1400 may serve as a fuel source for continuous or intermittent power generation to supply on-site electrical loads and/or to support grid-parallel operation, depending on the selected operating mode.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### III. Claim Clauses

Clause 1. A system for generating power, the system comprising: a power generation unit comprising: an internal combustion engine, a gearbox operably coupled to the internal combustion engine, wherein the gearbox comprises a reduction gearbox that has a reduction ratio ranging from 1.1:1 to 5:1, and a generator connected to the gearbox, wherein the generator provides power to one or more output devices; and a computing device for controlling the power generation unit, wherein the computing device controls the power generation unit based on one or more characteristics relating to the power generation unit.

Clause 2. The system of Clause 1, wherein the reduction gearbox is structured to provide from approximately 2:1 to approximately 2.5:1 reduction ratio.

Clause 3. The system of Clause 1, wherein the reduction gearbox increases torque by changing a revolutions per minute provided to the generator.

Clause 4. The system of Clause 3, wherein the reduction gearbox allows for the revolutions per minute to be consistent with an operating parameter of the generator.

Clause 5. The system of Clause 3, wherein the gearbox receives an input torque at an input speed from the internal combustion engine and outputs an output torque at an output speed to the generator, wherein the output torque is higher than the input torque based on the reduction ratio and an efficiency of the gearbox.

Clause 6. The system of Clause 5, wherein the input speed is higher than the output speed based on the reduction ratio and the efficiency of the gearbox.

Clause 7. The system of Clause 5, wherein the gearbox comprises a plurality of gears to convert the input torque at the input speed into the output torque at the output speed.

Clause 8. The system of Clause 5, wherein the efficiency of the gearbox is at least 95%.

Clause 9. The system of Clause 1, wherein the gearbox is structured to reduce a revolutions per minute provided to the generator from the internal combustion engine.

Clause 10. The system of Clause 1, wherein the internal combustion engine is fueled via natural gas or diesel.

Clause 11. The system of Clause 1, wherein the power generation unit further comprises a frame, wherein the frame allows the power generation unit to be moved.

Clause 12. The system of Clause 1, wherein the power generation unit is mobile via a trailer.

Clause 13. The system of Clause 1, wherein the internal combustion engine is structured to operate on flare gas.

Clause 14. The system of Clause 13, wherein the one or more characteristics comprise a methane content of the flare gas, wherein the computing device adjusts an operation of the internal combustion engine based on the methane content.

Clause 15. The system of Clause 1, further comprising one or more sensors for monitoring the power generation unit.

Clause 16. The system of Clause 15, wherein the one or more sensors comprise at least one of an engine sensor, a gearbox sensor, or a generator sensor.

Clause 17. The system of Clause 1, wherein the one or more characteristics are related to an output of the generator to the one or more output devices.

Clause 18. The system of Clause 1, wherein the reduction ratio is based on an RPM of the internal combustion engine and a desired RPM of the generator.

Clause 19. The system of Clause 1, wherein the one or more characteristics comprise at least one of temperature, pressure, voltage, or frequency.

Clause 20. The system of Clause 1, wherein the one or more characteristics relate to at least one of the generator or the internal combustion engine.

Clause 21. A power generation unit comprising: an internal combustion engine, a gearbox operably coupled to the internal combustion engine, wherein the gearbox comprises a reduction gearbox that has a reduction ratio ranging from 1.1:1 to 5:1, and a generator connected to the gearbox, wherein the generator provides power to one or more output devices.

Clause 22. The power generation unit of Clause 21, wherein the reduction gearbox is structured to provide from approximately 2:1 to approximately 2.5:1 reduction ratio.

Clause 23. The power generation unit of Clause 21, wherein the reduction gearbox increases torque by changing a revolutions per minute provided to the generator.

Clause 24. The power generation unit of Clause 23, wherein the reduction gearbox allows for the revolutions per minute to be consistent with an operating parameter of the generator.

Clause 25. The power generation unit of Clause 23, wherein the gearbox receives an input torque at an input speed from the internal combustion engine and outputs an output torque at an output speed to the generator, wherein the output torque is higher than the input torque based on the reduction ratio and an efficiency of the gearbox.

Clause 26. The power generation unit of Clause 25, wherein the input speed is higher than the output speed based on the reduction ratio and the efficiency of the gearbox.

Clause 27. The power generation unit of Clause 25, wherein the gearbox comprises a plurality of gears to convert the input torque at the input speed into the output torque at the output speed.

Clause 28. The power generation unit of Clause 25, wherein the efficiency of the gearbox is at least 95%.

Clause 29. The power generation unit of Clause 21, wherein the gearbox is structured to reduce a revolutions per minute provided to the generator from the internal combustion engine.

Clause 30. The power generation unit of Clause 21, wherein the internal combustion engine is fueled via natural gas or diesel.

Clause 31. The power generation unit of Clause 21, wherein the power generation unit further comprises a frame, wherein the frame allows the power generation unit to be moved.

Clause 32. The power generation unit of Clause 21, wherein the power generation unit is mobile via a trailer.

Clause 33. The power generation unit of Clause 21, wherein the internal combustion engine is structured to operate on flare gas.

Clause 34. The power generation unit of Clause 21, further comprising one or more sensors for monitoring the power generation unit.

Clause 35. The power generation unit of Clause 34, wherein the one or more sensors comprise at least one of an engine sensor, a gearbox sensor, or a generator sensor.

Clause 36. The power generation unit of Clause 21, wherein the reduction ratio is based on an RPM of the internal combustion engine and a desired RPM of the generator.

Clause 37. A method of manufacturing a power generation unit, the method comprising: providing an internal combustion engine, coupling a gearbox to the internal combustion engine, wherein the gearbox comprises a reduction gearbox that has a reduction ratio ranging from 1.1:1 to 5:1, and connecting a generator to the gearbox, wherein the generator provides power to one or more output devices.

Clause 38. The method of Clause 37, wherein the reduction gearbox is structured to provide from approximately 2:1 to approximately 2.5:1 reduction ratio.

Clause 39. The method of Clause 37, wherein the reduction gearbox increases torque by changing a revolutions per minute provided to the generator.

Clause 40. The method of Clause 39, wherein the reduction gearbox allows for the revolutions per minute to be consistent with an operating parameter of the generator.

Clause 41. The method of Clause 39, wherein the gearbox receives an input torque at an input speed from the internal combustion engine and outputs an output torque at an output speed to the generator, wherein the output torque is higher than the input torque based on the reduction ratio and an efficiency of the gearbox.

Clause 42. The method of Clause 41, wherein the input speed is higher than the output speed based on the reduction ratio and the efficiency of the gearbox.

Clause 43. The method of Clause 41, wherein the gearbox comprises a plurality of gears to convert the input torque at the input speed into the output torque at the output speed.

Clause 44. The method of Clause 41, wherein the efficiency of the gearbox is at least 95%.

Clause 45. The method of Clause 37, wherein the gearbox is structured to reduce a revolutions per minute provided to the generator from the internal combustion engine.

Clause 46. The method of Clause 37, wherein the internal combustion engine is fueled via natural gas or diesel.

Clause 47. The method of Clause 37, wherein the power generation unit further comprises a frame, wherein the frame allows the power generation unit to be moved.

Clause 48. The method of Clause 37, wherein the power generation unit is mobile via a trailer.

Clause 49. The method of Clause 37, wherein the internal combustion engine is structured to operate on flare gas.

Clause 50. The method of Clause 37, further comprising providing one or more sensors for monitoring the power generation unit.

Clause 51. The method of Clause 50, wherein the one or more sensors comprise at least one of an engine sensor, a gearbox sensor, or a generator sensor.

Clause 52. The method of Clause 37, wherein the reduction ratio is based on an RPM of the internal combustion engine and a desired RPM of the generator.

Therefore, the following is claimed:

1. A system for generating power, the system comprising:
a power generation unit comprising:
an internal combustion engine,
a gearbox operably coupled to the internal combustion engine, wherein the gearbox comprises a reduction gearbox that has a reduction ratio ranging from 1.1:1 to 5:1, and
a generator connected to the gearbox, wherein the generator provides power to one or more output devices; and
a computing device for controlling the power generation unit, wherein the computing device controls the power generation unit based on one or more characteristics relating to the power generation unit.

2. The system of claim 1, wherein the reduction gearbox is structured to provide from approximately 2:1 to approximately 2.5:1 reduction ratio.

3. The system of claim 1, wherein the gearbox receives an input torque at an input speed from the internal combustion engine and outputs an output torque at an output speed to the generator, wherein the output torque is higher than the input torque based on the reduction ratio and an efficiency of the gearbox.

4. The system of claim 3, wherein the input speed is higher than the output speed based on the reduction ratio and the efficiency of the gearbox.

5. The system of claim 1, wherein the internal combustion engine is fueled via natural gas or diesel.

6. The system of claim 1, wherein the power generation unit is mobile via a trailer.

7. The system of claim 1, wherein the internal combustion engine is structured to operate on flare gas.

8. The system of claim 7, wherein the one or more characteristics comprise a methane content of the flare gas, wherein the computing device adjusts an operation of the internal combustion engine based on the methane content.

9. The system of claim 1, further comprising one or more sensors for monitoring the power generation unit.

10. The system of claim 9, wherein the one or more sensors comprise at least one of an engine sensor, a gearbox sensor, or a generator sensor.

11. The system of claim 1, wherein the one or more characteristics comprise at least one of temperature, pressure, voltage, or frequency.

12. A power generation unit comprising:
an internal combustion engine,
a gearbox operably coupled to the internal combustion engine, wherein the gearbox comprises a reduction gearbox that has a reduction ratio ranging from 1.1:1 to 5:1, and
a generator connected to the gearbox, wherein the generator provides power to one or more output devices.

13. The power generation unit of claim 12, wherein the reduction gearbox is structured to provide from approximately 2:1 to approximately 2.5:1 reduction ratio.

14. The power generation unit of claim 12, wherein the internal combustion engine is fueled via natural gas or diesel.

15. The power generation unit of claim 12, wherein the power generation unit is mobile via a trailer.

16. The power generation unit of claim 12, wherein the internal combustion engine is structured to operate on flare gas.

17. The power generation unit of claim 12, further comprising one or more sensors for monitoring the power generation unit.

18. The power generation unit of claim 17, wherein the one or more sensors comprise at least one of an engine sensor, a gearbox sensor, or a generator sensor.

19. A method of manufacturing a power generation unit, the method comprising:
providing an internal combustion engine,
coupling a gearbox to the internal combustion engine, wherein the gearbox comprises a reduction gearbox that has a reduction ratio ranging from 1.1:1 to 5:1, and
connecting a generator to the gearbox, wherein the generator provides power to one or more output devices.

20. The method of claim 19, wherein the reduction gearbox is structured to provide from approximately 2:1 to approximately 2.5:1 reduction ratio.
